(19) United States
(12) Patent Application Publication
(10) Pub. No.: US 2004/0166881 A1
(43) Pub. Date: Aug. 26, 2004

(54) Phased array wireless location method and apparatus

(76) Inventor: David Walter Farchmin, Grafton, WI (US)

Correspondence Address: Susan M. Donahue, Rockwell Automation Inc. -704-P, 1201 South Second Street, Milwaukee, WI, 53204-2496, US

(21) Appl. No.: 10/361,199

(22) Filed: Feb. 6, 2003

(51) Int. Cl. H04Q 7/20

(52) U.S. Cl. 455/457

(57) ABSTRACT

A method and apparatus for determining the location of an item within a facility where the facility includes at least one stationary point and the item and the stationary point are each facility objects, the method comprising the steps of providing a receiver on a first of the objects, providing a transmitter on a second of the objects, wherein at least one of the receiver and transmitter include a phased array antenna, where the receiver includes the antenna, causing the antenna to receive signals within at least first and second different profiles and causing the transmitter to transmit signals to the receiver, where the transmitter includes the antenna, causing the antenna to transmit signals having at least first and second different profiles and causing the receiver to receive at least a sub-set of the transmitted signals and combining the received signals to determine the location of the item.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The field of the invention is wireless location based systems and more specifically the use of phased array antennas to obtain data within a facility related to the location of an item within the facility and which can be used to statistically estimate item location.

Many industries have recognized that there is value in being able to distribute specific information to electronic equipment as a function of the location of the equipment within a facility. For instance, when a portable computer is moved to a specific location within a building it has been recognized as advantageous to be able to provide location specific information via the computer such as information related to the closest printer, or fax machine, regarding location specific HVAC functionality, related to a video projector, etc. As another instance, many museums have recently adopted systems whereby patrons are issued portable wireless information devices that can be carried about the museum and used to obtain either audio or video presentations or both related to proximate exhibits. As one other instance, in the machine automation industry it has been recognized as advantageous to be able to provide machine specific information to portable electronic interfaces to facilitate machine configuration, monitoring and control. Hereinafter portable interfaces for providing location based data will be referred to as wireless information devices (WIDs).

Generally, provision of location based data to WIDs is a three step process. First WID location has to be determined. Second, data corresponding to the specific WID location has to be identified. Third, the identified data has to be transmitted to the WID for presentation to the WID user. While the data identifying step has proven to be relatively simple, the steps of determining WID location and transmitting data to wireless devices have proven to be more difficult tasks to perform efficiently.

European patent application No. 0,992,921 (hereinafter “the '921 reference”) entitled “Computer Access Dependent On Location of Access Terminal” which was filed on Sep. 21, 1999 teaches a facility system wherein a separate wireless access point is positioned within each of several different facility rooms for communicating with a physician's wireless device located within the room. The '921 reference teaches that when a wireless device is sensed in a room, information specific to the patient within the room is provided to the wireless device for presentation to the physician.

The '921 solution works well in a facility that can easily be divided into cells separated by walls (i.e., patient rooms) and where there is only one set of information (i.e., information related to a single patient) associated with a particular cell. However, if a plurality of patients are located within a single room the '921 reference system cannot determine for which of the plurality of patients a physician seeks information. It is unclear how the '921 reference would resolve the quandary regarding which patient information to provide to a physician when more than one patient resides in a room. The '921 reference presents a problem where a physician may end up reviewing information corresponding to one patient while examining a different patient in the same room—clearly an unacceptable situation. In the context of an automated facility the '921 reference could not be used to select information corresponding to one machine out of a plurality of machines in a room for delivery to an HHD. In addition, in this regard, in many automated environments, several hundred or even thousand monitorable/controllable machines may be located in a single room or space and many of the machines may have similar descriptions so that, for instance, identifying one drill press from within a room including 100 drill presses would be a potentially confusing task.

In addition, the '921 reference system and other systems of the same ilk require a relatively large number of access points to provide even the relatively coarse location resolution capabilities contemplated. System cost increases along with component count and therefore systems like the '921 reference system are relatively expensive.

World patent application No. WO 00/50919 (hereinafter “the '919 reference”) which is titled “Method and Computer Readable Medium for Locating and Tracking a User in a Wireless Network Using a Table of Digital Data” teaches one system that can be used to relatively accurately determine location within a specific space or within a room. To this end, the '919 reference teaches that a plurality of base stations or access points can be installed at locations within a facility. The access points each transmit access point identifying signals of known strength to mobile handheld devices (HHDs) within the facility. The strengths of the signals decrease as a function of distance traveled by the signals. The HHDs each receive the transmitted signals and, based on signal strengths of several of the received signals, determine HHD location within the facility.

One of the primary problems encountered when transmitting data to wireless devices within a facility is transmission range. In this regard typical access points have a statutorily regulated limited maximum transmit power level and transmit data omni-directionally (e.g., horizontally in all directions through 360 degrees). Thus, while a receiving wireless device is only located at a single angle with respect to an access point, the point directs energy along all angles, only a small fraction of the energy is transmitted along a trajectory directed at the wireless device and hence the range of transmission is severely limited.

One solution to the transmission problem has been to provide access points capable of identifying optimal trajectories for delivering data to a wireless device and that can then be used to direct transmissions along the optimal trajectories. Phased array or “directional” antennas have successfully been employed to identify optimal trajectories and then transmit and receive along those trajectories while suppressing signals received along other trajectories thereby increasing transmission and reception range appreciably.

To identify an optimal trajectory, a phased array antenna is used to obtain signal transmitted by a wireless device along different trajectories directed toward an access point and some protocol is used to identify the optimal trajectory between the wireless device and access point. For instance, in any open area (e.g., outdoors) where there is likely to be a clear and unobstructed path between a wireless device and an access point, an exemplary protocol may identify the trajectory of an earliest received signal from a wireless device as the optimal trajectory along which to communicate with the wireless device. Because signals are minimally obstructed in an open environment, the earliest received signal typically has a trajectory that corresponds to a direct line of sight between the access point and the wireless device and hence, therefore, the trajectory of the earliest received signal usually corresponds to the optimal communication trajectory.

As another instance, in a closed area like an automated facility where it is relatively likely that there will be obstructions between a wireless device and an access point and hence that signals transmitted by the wireless device will reflect and change directions several times and may even pass through energy absorbing media prior to reception by the access point, an exemplary protocol may identify the trajectory of the strongest received signal as the optimal communication trajectory while ignoring all other trajectories.

Once an optimal communication trajectory is identified, the access point simply adapts its communication (e.g., transmission and reception) trajectory to match the optimal trajectory. As well known in the phased array art, by focusing the statutorily limited maximum transmit power along a single optimal trajectory between the access point and a wireless device, transmission range can be extended appreciably. Reception range is extended by increasing the gain of signals received along the optimal trajectory and suppressing signals received along other trajectories.

In addition to being used to identify an optimal communication trajectory and thereafter transmit data along the trajectory, it has also been recognized that when in an open and unobstructed area, two or more phased array access points can be used to determine the location of a wireless device within the unobstructed area. In this regard, if each of two access points can be used to independently identify a trajectory between the access point and a wireless device, the intersection of the trajectories will correspond to the instantaneous location of the wireless device (i.e., the intersection of two straight lines is a point or location).

While the '919 reference system and systems that employ multiple cooperating phased array access points advantageously reduce the cost of a location tracking system by reducing the number of access points within a facility required to identify device location, it is believed that the location resolution and reliability attainable via the '919 reference system and phased array type systems will not be sufficient for congested indoor environments (e.g., an automated factory environment). The primary shortcoming of all of the device location determining systems described above is that each of the systems relies upon direct and un-reflected propagation of signals between the WID and the access points. Thus, in the case of the '919 reference, the location determining algorithm assumes direct and un-reflected signal propagation. Here, if a reflected signal is received and employed to determine device location, the location determination is erroneous. Similarly, in the case of a phased array location determining system, each of the signals from each phased array antenna that are used to identify location must correspond to an unobstructed line of sight between the antenna and the device to yield a correct location determination. Unfortunately, typical indoor facilities include many signal reflecting and attenuating surfaces and structures such that it is very rare for a transmitted signal to be received by an access point un-reflected and un-attenuated.

World patent application No. WO 02/054813 (hereinafter “the '813 reference”) titled “Location Estimation in Wireless Telecommunication Networks” teaches a location system similar to the system described in the '919 reference that relies on signal strength to determine location of a portable device within a facility. The '813 patent, however, applies a statistical model to the received signals and yields a relatively accurate device location estimate independent of whether or not signals received by access points have been obstructed, reflected, etc. In general, the '813 reference teaches that access points are used during a commissioning procedure to omni-directionally transmit access point identifying signals to a wireless device. The wireless device receives the signals, identifies signal strengths of each identifying signal and then stores known wireless device locations with corresponding sets of access point specific signal strengths. After a number of different location-signal sets have been generated and stored (i.e., after completing the commissioning process) and during normal operation, the access points within the facility are controlled to again transmit signals to the wireless device. The wireless device receives signals, identifies measured signal sets, compares an instantaneous measured signal set to the stored location-signal sets and determines device location by identifying the closest signals set match. Thus, if the measured signal set “exactly” matches a stored location-signal set then wireless device location is determined. In most cases the measured signal set will not precisely match a stored location-signal set. Here, where the measured signal set is different than stored sets, the '813 reference teaches an estimation/interpolation process to identify device location.

The method described in the '813 reference may be performed in the opposite direction where a wireless device transmits signals to access points during both commissioning and location determination and then a processor linked to the access points performs signal set storage and a statistical analysis.

One apparent problem with the '813 reference is that precision of the '813 reference protocol, as in the case of virtually all statistical protocols, is related to the quantity of data used to generate the estimated location. Thus, precision of the '813 reference protocol increases as the amount of data obtained and used is increased.

In systems that include access points, the amount of data that can be obtained in a set period can be increased by increasing the number of access points within an area. Thus, for instance, where the number of access points within a facility is doubled, the amount of data obtained can generally be doubled and protocol precision can be increased appreciably. Unfortunately, increasing the number of access points increases overall system costs and hence should be avoided.

In addition, there are technical limitations to the numbers of access points that can be installed within a specific facility area. To this end, most access points communicate according to the IEEE 802.11b standard protocol which, as well known in the wireless art, is restricted by the FCC to include only 11 separate channels within the 2.4 GHz ISM band. The channels start at 2.412 GHz and are separated by 0.005 GHz (5 MHz). To distinguish access point signals, the signal frequencies have to be distinct. Thus, access points generally have to be positioned such that, at any specific location within a facility, signals at a specific frequency are only received from one access point (e.g., access points at any one of the 11 channel frequencies must be spatially separated to sustain signal integrity).

Complicating matters further, wireless network configuration cost constraints have forced designers to employ access points that, in some cases, are incapable of distinguishing between signals transmitted at similar channel frequencies. For example, despite attempts to tune an access point to monitor for signals at a channel 7 frequency, the access point may be incapable of distinguishing between signals at the channel 6, channel 7 and channel 8 frequencies.

To eliminate the problems associated with access points that cannot distinguish between signals at similar channel frequencies, system designers typically separate access points tuned to similar frequencies. For instance, instead of tuning adjacent access points to monitor channels 6 and 7, the adjacent points may be tuned to monitor channels 6 and 11 or 6 and 3, etc.

Clearly, despite these channel tuning “tricks”, the limited number of available distinct channels for communication limits the number of access points useable to generate data and hence limits the amount of data available for statistical analysis. In addition, despite efforts to avoid signal confusion via relative tuning of adjacent access points, it has been recognized that inexpensive access point receivers may still have difficulties distinguishing signal frequencies where access point coverage areas overlap. In fact, even where spatially adjacent access points are configured and tuned to have wide channel separations (e.g., channels 6 and 11), where the physical separation of the access points is very small, capability to distinguish signals at similar channel frequencies is imperfect.

Therefore, it would be advantageous to have a wireless system that could increase the amount of data available for statistically determining the location of wireless devices within an area. It would also be advantageous to have a system that meets the above objective without appreciably increasing overall system costs.

### BRIEF SUMMARY OF THE INVENTION

It has been recognized that phased array antennas can be used to increase the amount of data available for statistical analysis of device location and hence can, in short, be used to increase the precision of location estimation. To this end, for instance, in at least some embodiments of the invention, each access point may include a phased array antenna capable of transmitting signals having several (e.g., 4, 10, 15, etc.) different profiles. Each access point can then be controlled to transmit the different profile signals one at a time, in rapid succession within an area. Typically, when a wireless information device (WID) is proximate a transmitting access point, at least some of the transmitted signal is received by the WID. The WID uses information in the received signals to identify both the transmitting access point and the specific profile associated with the received signal. The WID correlates the access point, profile and signal strength data for each received signal as a measured location specific data sub-set. When sufficient data is collected to determine WID location, the WID performs a statistical analysis to determine location.

Generally, the statistical analysis includes comparing the measured data to data generated during a commissioning procedure whereby known WID locations are correlated with learned access point identifier, profiles and signal strengths.

It should be appreciated that in at least the embodiments including phased array access points, each point/profile combination is treated like a separate access point for data generation purposes. Thus, for example, where an access point transmits four different profiles, the four separate access point/profile combinations each generates a separate measured location specific data sub-set (or “learned” data sub-set during commissioning) which is then combined with other sub-sets to determine location.

In some embodiments, instead of, or in addition to, providing phased array access points, the WID may be provided with a phase array antenna for transmitting signals to the access points where the transmitted signals have different profiles. Here the WID also includes an orientation determiner so that the orientation (N, S, E, W, angle, etc.) of the WID can also be determined and used to either adjust the antenna to generate profiles of known trajectory or to remap signals to required profiles after access points receive signals.

In yet one other inventive embodiment, phased array access points may be tuned to receive signals along different profiles to generate additional data for statistical analysis. In this case, when the WID transmits signals, each access point sequentially receives the transmitted signal along each separate profile and suppresses signals along other profiles to generate data. Here, again, each access point/profile combination is treated like a separate access point for the purpose of data generation.

In one other embodiment a phased array WID antenna may be programmed to receive data along different profiles adjusted for WID orientation to generate additional data.

Consistent with the above, the invention includes a method for determining the location of an item within a facility wherein the facility includes at least one stationary point, and the item and the stationary point are each facility objects, the method comprising the steps of providing a receiver on a first of the objects, providing a transmitter on a second of the objects, wherein at least one of the receiver and the transmitter includes a phased array antenna, where the receiver includes the antenna, causing the antenna to receive signals within at least first and second different profiles and causing the transmitter to transmit signals to the receiver, where the transmitter includes the antenna, causing the antenna to transmit signals having at least first and second different profiles and causing the receiver to receive at least a sub-set of the transmitted signals and using the received signals to determine the location of the item.

The invention also includes a method for determining the location of an item within a facility wherein the facility includes at least one stationary point, the method comprising the steps of providing a receiver on the item, providing a transmitter including a phased array antenna at the stationary point, causing the antenna to transmit signals within the facility having at least first and second different profiles, receiving at least a sub-set of the transmitted signals via the receiver and performing a statistical analysis on the received signals to determine the location of the item.

In addition, the invention includes a method for determining location within an area wherein the area includes at least one stationary point, the method comprising the steps of transmitting signals from the stationary point along at least first and second different profiles within the area, receiving at least a subset of the transmitted signals at a location within the area, determining the signal strengths of the received signals, correlating the signal strengths with the profiles and performing a statistical analysis on at least first and second of the correlated profile/signal strength combinations to determine location within the area.

Moreover, the invention includes a method for determining location within an area, the method comprising the steps of performing a commissioning procedure including the steps of: (a) transmitting signals from a first location within the area along at least first and second different profiles within the area; (b) receiving at least a subset of the transmitted signals at a second location within the area, at least one of the first and second locations being a known location; (c) determining the signal strengths of the received signals; (d) correlating the signal strengths with the profiles and the known location to generate a learned location data set; (e) storing the learned data set for sub-sequent use and (f) repeating steps (a) through (e) for a plurality of locations within the area.

The invention further includes a method for determining location within an area, the method comprising the steps of transmitting signals from a first location within the area along at least first and second different profiles within the area, receiving at least a subset of the transmitted signals at a second location within the area, determining the signal strengths of the received signals, correlating the signal strengths with the profiles to generate a measured location data set and using the measured data set to determine the second location.

According to some embodiments of the invention a method is provided for determining location within an area, the method comprising the steps of transmitting profile sequence information within the area, the sequence information indicating the sequence of X profiles to be transmitted subsequently within the area, receiving and storing the profile sequence information, transmitting signals along the X profiles within the area, receiving at least a sub-set of the transmitted signals at a location within the area, determining the signal strengths of at least a subset of the received signals, correlating the signal strengths and the profiles specified by the profile sequence to generate a measured location data set and using the measured data set to determine the receiving location within the area.

The invention additionally includes a system for determining the location of an item within a facility wherein the facility includes at least one stationary point, and the item and the stationary point are each facility objects, the system comprising a receiver on a first of the objects, a transmitter on a second of the objects, wherein at least one of the receiver and the transmitter includes a phased array antenna, where the receiver includes the antenna, a receiver processor causing the antenna to receive signals within at least first and second different profiles and causing the transmitter to transmit signals to the receiver, where the transmitter includes the antenna, a transmitter processor causing the antenna to transmit signals having at least first and second different profiles and causing the receiver to receive at least a sub-set of the transmitted signals and a processor using the received signals to determine the location of the item.

Moreover, the invention also includes a system for determining the location of an item within a facility wherein the facility includes at least one stationary point, the system comprising a receiver on the item, a transmitter including a phased array antenna at the stationary point, a transmitter processor causing the antenna to transmit signals within the facility having at least first and second different profiles and a processor programmed to perform a statistical analysis of the received signals to determine the location of the item.

Furthermore, the invention includes a system for determining location within an area, the system comprising a transmitter transmitting signals from a first location within the area along at least first and second different profiles within the area, a receiver receiving at least a subset of the transmitted signals at a second location within the area, at least one of the first and second locations being a known location, a processor determining the signal strengths of the received signals, correlating the signal strengths with the profiles and the known location to generate a learned location data set and a memory linked to the processor for storing the learned data set for sub-sequent use.

Also, the invention includes a system for determining location within an area, the system comprising a transmitter transmitting signals from a first location within the area along at least first and second different profiles within the area, a receiver receiving at least a subset of the transmitted signals at a second location within the area and a processor that determines the signal strengths of the received signals, correlates the signal strengths with the profiles to generate a measured location data set and uses the measured data set to determine the second location.

According to one aspect the invention includes an apparatus for determining the location of an item within a facility, the apparatus for use with at least one phased array transmitter that transmits signals along at least first and second different profiles within the facility, the apparatus comprising a receiver mounted to the item, the receiver for receiving at least a sub-set of the signals transmitted along the different profiles and a processor that determines the strengths of the received signals, correlates the received signal strengths with associated profiles and uses the correlated signal strength/profile combinations to determine item location within the facility.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a schematic diagram illustrating an exemplary industrial facility and zone aspects according to the present invention;

FIG. 2 is schematic diagram illustrating signal paths of signals transmitted from an access point to a wireless information device;

FIG. 3 is a schematic diagram illustrating three signals profile patterns that may be generated by a phased array access points;

FIG. 4 is similar to FIG. 3, albeit illustrating fifteen different signal profiles that may be generated by an access point;

FIG. 5a is a perspective view of an exemplary wireless information device WID used with the present invention;

FIG. 5b is a schematic diagram illustrating various components of the device of FIG. 5a;

FIG. 6 is a flow chart illustrating a commissioning procedure according to one embodiment of the present invention;

FIG. 7 is a flow chart illustrating a data generating and location determining method according to one embodiment of the present invention;

FIG. 8 is a sub-process that may be substituted for a portion of the process in FIG. 7;

FIG. 9 is a schematic diagram similar to the diagram of FIG. 5b, albeit illustrating another embodiment of a wireless information device according to one embodiment of the present invention;

FIG. 10 is a flow chart illustrating a commissioning procedure according to another embodiment of the present invention;

FIG. 11 is a flow chart illustrating a data generating and location determining method according to another embodiment of the present invention;

FIG. 12 is a sub-process that may be substituted for a portion of the process of FIG. 10;

FIG. 13 is a sub-process that may be substituted for a portion of the process of FIG. 11;

FIG. 14 is yet one other commissioning process according to another embodiment of the present invention;

FIG. 15 is one other location determining and data generating method according to the present invention;

FIG. 16 is another commissioning method according to the present invention; and

FIG. 17 is one other data generating and location determining method according to the present invention.

### DETAILED DESCRIPTION OF THE INVENTION

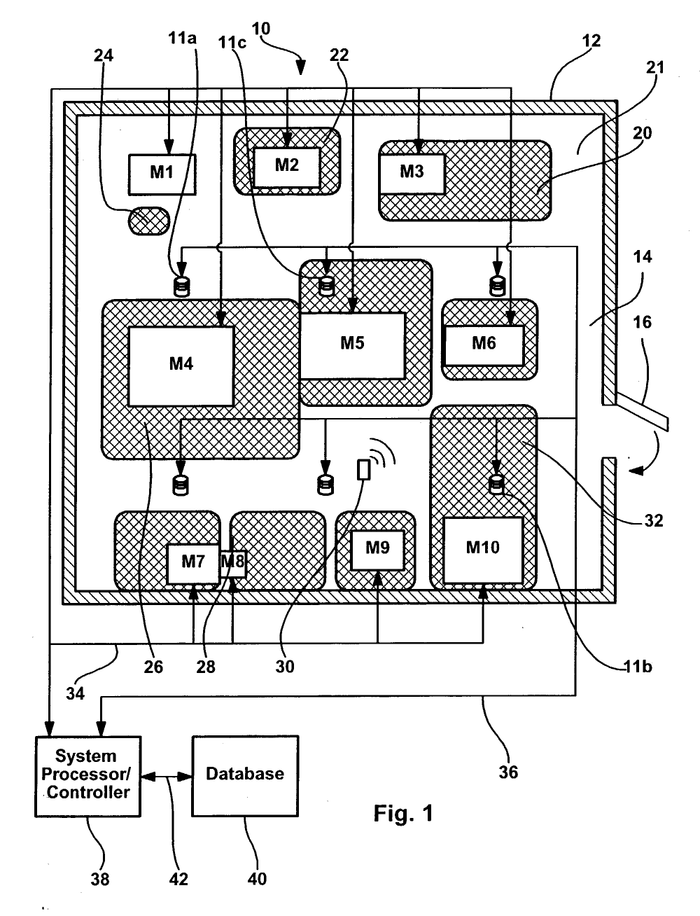

Referring now to the drawings wherein like reference numbers correspond to similar elements throughout the several views and, more specifically, referring to FIG. 1, the present invention will be described in the context of an exemplary, albeit simplified, manufacturing facility 10 that includes a rectilinear facility floor space or area 14 confined by four facility walls collectively identified by numeral 12. In the exemplary facility 10, the entire area 14 comprises a single room (i.e., there are no wall partitions within facility 10 and all of the facility resides on a single level). A doorway 16 is provided to allow access to area 14.

Exemplary facility 10 includes ten separate machines identified by labels M1 through M10. The exemplary machines M1 through M10 may include any type of manufacturing machine such as a mill, a drill, a transfer line, a laser cutting device, a vision system, any of several different types of robots, clamps, etc. The machines M1 through M10 are shown as being different sizes to visually illustrate that the machines may have very different physical footprints. For example, machine M4 is illustrated as having a much larger physical footprint than machine M8. In general, the machines M1-M10 are spaced out within area 14 although, in some cases, machines may be positioned directly next to each other such as, for instance, machines M7 and M8 in FIG. 1.

In FIG. 1 it is contemplated that each of machines M1-M10 includes at least one and, in many cases, a plurality of sensing devices (not illustrated) that sense machine operating characteristics and provide signals that can be used to facilitate machine monitoring via an interface (i.e., a WID). For instance, in the case of a drilling machine, sensors may include limit switches that are tripped when a drill slide reaches various positions along a travel path, on/off switches, speed sensing switches, motor operating characteristic sensors, etc.

In addition to including sensing devices, it is contemplated that most, if not all, of machines M1-M10 will include some type of control interface to facilitate control and control adjustment. For example, again, in the case of a drilling machine, drill slide stroke length may be altered, drill speed may be altered, the angle at which a drill bit enters a work piece may be altered, etc.

Referring still to FIG. 1, in addition to the components described above, facility 10 also includes a plurality of communication access points 11a,11b, etc., (stationary points, referred to generally hereinafter by numeral 11), a system processor/controller 38, a database 40, at least one wireless information device (WID) 30 and a plurality of two-way data buses 34, 36 and 42. Controller 38 may be positioned within facility 10 or may be located at some remote location such as, for instance, in a separate building, in a separate room within the facility that includes area 14 or at a completely different location such as a remote campus associated with facility 10. In addition, in many industrial environment, controller 38 will be physically associated with specific machine lines so that the controller 38 may be positioned, for instance, at the front end of a line of machines to facilitate easy access to machine operating characteristics adjacent the machines and/or to allow operating characteristics to be altered in a proximate manner. In FIG. 1, controller 38 is linked to each of machines M1-M10 via a two-way data bus 34 that allows controller 38 to monitor machine operating characteristics as well as control machine operation.

Controller 38 is typically a processor (typically having PLC capabilities) based workstation capable of running various types of computer programs. For instance, some programs are machine control programs that enable controller 38 to either separately control each machine M1-M10 or, safely and precisely sequence machine operation thereby allowing relatively complex manufacturing processes to be performed in an efficient manner. In addition, other controller programs may allow controller 38 to derive various machine operating characteristics from monitored or sensed characteristics (e.g., motor voltage and current data is useful to derive stator and rotor resistance estimates, system inductances, identify harmonics, determine system torques, etc.) and to run complex algorithms to identify operating trends, alarm conditions, potentially unsafe conditions, maintenance requirements, raw material requirements and so on. Moreover, controller 38 also runs programs that facilitate data management and warehousing so that subsequent algorithms may be applied to warehoused data to identify historical operating patterns for various purposes.

Furthermore, controller 38 runs programs designed to support interfacing with facility operators (e.g., maintenance personnel, process engineers, etc.) thereby providing control capabilities and system monitoring capabilities. To this end, controller 38 may include its own input and output interfacing devices such as a display screen, a keyboard, a pointing and selecting device such as a mouse or trackball or any other types of interfacing devices known in the art. Although not illustrated, other interfacing devices may be provided within facility 10 to enable monitoring and control.

In addition, in at least some embodiments, controller 38 will perform a location determining algorithm to determine the locations of one or more WIDs 30 within facility 10 as described in greater detail below. In other embodiments controller 38 may be programmed to control access points 11a, 11b, etc. to transmit signals having various profiles or to monitor for signals received from within various profiles as described in greater detail below.

Controller 38 is linked via two-way data bus 42 to data base 40. Controller programs are stored in database 40. In addition, data generated by controller 38 is stored in database 40 and can be accessed to allow examination of historical machine operating characteristics, real time operating characteristics and any other data generated by algorithms performed by controller 38.

Referring still to FIG. 1, each access point 11 includes a two-way wireless transceiver that, as well known in the computer arts, is capable of transmitting and receiving electromagnetic (e.g., RF, infrared, etc.) signals within an area proximate the transceiver. Wireless transceivers like access points 11 transmit information signals which decrease in strength as distances from the transceiver increase. In the illustrated example, six separate access points (only two labeled) are provided within area 14 and are generally equi-spaced within area 14. Typically, access points 11 will be mounted on the ceiling within an area 14 to generally allow the most unobstructed communication possible between an access point 11 and other devices that communicate therewith. While access points 11 are illustrated as being substantially equi-spaced within area 14, it should be appreciated that other access point arrangements are contemplated and that, in many cases, other access point arrangements may be most suitable given specific machine layouts, the physical characteristics of each machine and machine zone layouts (described below).

Controller 38 is linked to each access point 11 via a two-way data bus 36 which allows controller 38 to receive information from the access points 11 and also allows controller 38 to provide information to each of the access points 11 for transmission within area 14. Information is typically transmitted from a WID 30 to an access point 11 with a WID identifier tag specifying the WID transmitting the information as well as an access point identifier tag specifying the access point to which the information is being transmitted. The receiving access point associates itself with the transmitting WID for future communication, strips off the access point identifier tag and transmits the received information along with the WID identifier tag to the controller 38.

The controller 38 sends information to a WID 30 by broadcasting the information on a network linked to the access points with an identifier tag that specifies a specific WID as an intended recipient. Access points 11 monitor the network for information tagged as intended for WIDs that the access point is currently associated with. When information tagged as intended for a specific WID that an access point is associated with is received, the access point transmits the received information with the intended WID identifier tag and an access point identifier tag to the intended WID. The target WID receives and uses the transmitted information.

Referring still to FIG. 1, WID 30 is generally a wireless handheld device that includes a transceiver so that WID 30 can wirelessly transmit information and can wirelessly receive information via electromagnetic communication or some other suitable wireless communication. Thus, generally, WID 30 is equipped to communicate with any access point 11 in area 14. It should be appreciated that, while the illustrated area 14 is relatively small, many industrial facilities may include much larger spaces such as, for instance, spaces including tens of thousands of square feet. In these cases, it is contemplated that the transmitting distance of a typical WID 30 will be insufficient to transmit information to all access points within a facility. In other words, while WID 30 may be able to communicate with each access point 11 within a facility, communication will be limited by signal strength capabilities and reliable transmissions will require a WID proximate access points.

Referring still to FIG. 1, sub-spaces within area 14 are earmarked or identified as machine zones associated with each of the separate machines M1-M10. For instance, a space identified by numeral 24 includes a relatively small region adjacent machine M1 that is specifically associated with machine M1, space 24 referred to hereinafter as the machine zone associated with machine M1. Other numbered machine zones in FIG. 1 include machine zone 20 associated with machine M3, machine zone 26 associated with machine M4, machine zone 28 associated with machine M8 and machine zone 32 associated with machine M10. Each machine zone corresponds to a small region within area 14 in which it has been deemed suitable for a system operator (e.g., maintenance engineer, machine operator, etc.) to access machine operating characteristics and/or control the machine associated with a particular zone. For instance, when a system operator is within zone 26 it may be suitable for the operator to access operating characteristics corresponding to machine M4. Similarly, it may only be deemed suitable for an operator to control machine M1 when the operator is physically present within small zone 24.

The zone restrictions on access and control may be provided and enforced to increase facility safety and reduce operator confusion. For instance, if an operator were within zone 32 corresponding to machine MIO but was receiving access information corresponding to machine M2, the operator would clearly be confused. Similarly, if an operator were located within zone 24 corresponding to machine M1 but was receiving control information corresponding to machine M3, the operator may inadvertently and incorrectly alter operation of machine M3 while intending to alter operation of machine M1.

At least two different types of machine zones are contemplated including control zones and access zones. Control zones are typically relatively small regions proximate associated machines where, when a system operator is within the control zone, the operator is in a particularly advantageous position with respect to the machine to visually observe important operating characteristics of the machine and to observe the effects on machine operation that are caused by control modification. For example, with respect to machine M1, the best and perhaps the only region in which to observe machine operation sufficiently during control modification is small zone 24 which includes a portion of one side of machine M1.

It should be appreciated that each type of machine within a facility 10 will have different physical characteristics and therefore suitable control zones may be machine type specific. For instance, while small zone 24 corresponds to machine M1, the control zone corresponding to machine M6 may include space on all sides of machine M6. It should also be appreciated that there may be some machines where the machine simply operates and no control zone is provided. For example, in FIG. 1 machine M8 may not be associated with a control zone.

As its label implies, an access zone is a region in which it has been deemed suitable for a system operator to access or monitor an associated machine's operating characteristics (i.e., access information). For instance, when an operator is within zone 20 it may be suitable for the operator to access operating characteristics of machine M3. Similarly, when an operator is within zone 28 it may suitable for the operator to access operating characteristics of machine M8.

In FIG. 1 each of the illustrated zones, despite type, is shown as double crosshatched and only one zone is shown as being associated with each of the machines. Nevertheless, there may be several different zones associated with each machine and, indeed, there may be separate control and access zones associated with each machine. In some cases a single zone may be both a control and access zone.

Machine zones may be used for other than determination of where machines can be controlled and where information can be accessed. For instance, zones may also be used to determine when machines should be forced into fail safe modes of operation, may be combined with other information such as WID identification or WID user identification to identify sub-sets of information that should be provided within the zones to specific WIDs, etc. Moreover, the WID may include a device mounted to or otherwise associable with a specific machine which can be used to facilitate communication between a controller 38 and sub-processors of distributed controllers associated with the machine or to program a specific machine as a function of machine location. In any event, it should be appreciated that there are many advantages associated with knowing the precise location of a WID within an automated facility.

In at least one embodiment of the invention no physical markers are provided within area 14 to distinguish control and access zones and instead the zones are earmarked electronically on a facility map that resembles the schematic of FIG. 1 and that is stored in database 40 for access by controller 38.

Generally, in the context of the present invention and referring still to FIG. 1, controller 38 may control access and control information provided to WIDs 30 within facility 10 to ensure that machine access and control only takes place within the zones specified by the facility map stored in database 40. To this end, when a WID 30 is located within facility 10 and is turned on, controller 38, access points 11 and WID 30 cooperate to determine WID 30 location within facility 10. Once WID 30 location has been determined, controller 38 accesses the facility map in database 40 and determines if WID 30 is within one of the control or access zones corresponding to a specific machine. If WID 30 is within a machine specific zone, controller 38 accesses access and/or control information corresponding to a specific machine associated with the zone and provides that information to the WID 30 via a proximate access point 11. Thereafter, an operator can either access and monitor machine operation or, if within a control zone, may provide commands to controller 38 via proximate access points 11 to change machine operation.

In addition, in at least some embodiments of the invention, after access or control information has been provided to a WID 30 within a specific zone, if the WID 30 is removed from the zone, the system may determine that the WID 30 has been removed from the zone and may limit (e.g., render the information inaccessible via the WID, indicate that the WID is outside a zone, etc.) the access or control information in some fashion.

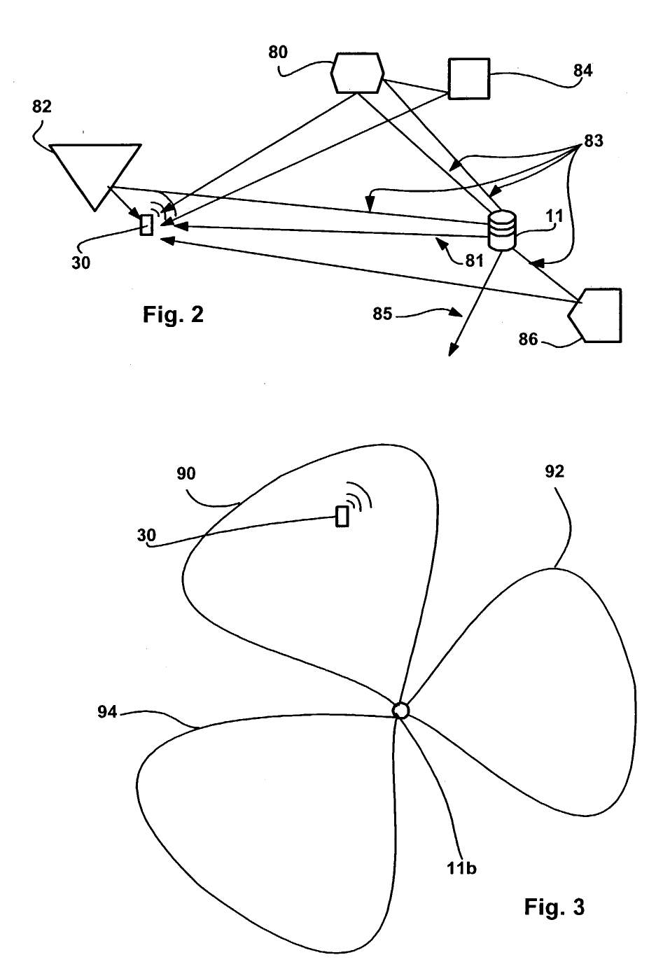

Referring now to FIG. 2, a single access point 11, a WID 30 and several different objects 80, 82, 84 and 86 that may be present within an exemplary, albeit simplified, automated manufacturing environment, are illustrated and will be used to explain how exemplary signals propagate within a facility 10. To this end, as illustrated, when access point 11 transmits signals to WID 30, where the access point 11 is an omni-directional point (e.g., broadcasts signals throughout a 360 degree horizontal broadcast profile centered on the access point location), a first portion of the signals may travel along trajectories 81 directly toward WID 30, a second portion of the signals travel along trajectories 83 (four trajectories shown) that reflect off one or more objects within the automated environment prior to being received by the WID 30 while a third portion of the signals travel along trajectories 85 (only one trajectory shown) that, despite reflections, fail to intersect the location of the WID prior to dissipating beyond the point of usefulness (i.e., the signals become too weak to be used).

It should be appreciated that most of the signals that are received by the WID travel along trajectories that, in and of themselves, have little to do with the direct trajectory between the access point 11 and the WID. Nevertheless, industry members have developed statistical algorithms that can use essentially all of the signals received by a WID, despite the receiving trajectories, to estimate WID location. As with most statistical algorithms, position determining statistical algorithm accuracy is increased when the amount of data employed is increased.

According to at least some embodiments of the present invention, one way to increase the amount of data available for position determination is to employ steerable or directional access points to generate a plurality (e.g., at least two) of different directed signal profiles at different times and then employ the resulting received signals to determine WID location. For example, where each directional access point employed generates two distinct transmission profiles, each of the access points in effect, operates like two separate access points and the amount of data useable to determine WID location can be increased essentially by a factor of two. Similarly, where each access point employed generates four distinct transmission profiles, each of the access points in effect, operates like four separate access points and the amount of data useable to determine WID location can be increased essentially by a factor of four.

Referring now to FIG. 3, a single access point 11b and three exemplary directed transmission profiles 90, 92 and 94 that may be generated thereby are illustrated. Here, while a WID may be located in a facility location that resides within profile 90 as illustrated, as described above with respect to FIG. 2, because signals reflect within an automated facility, even portions of signals transmitted within profiles 92 and 94 will typically be received by a WID within profile 90 and hence useful position data is obtained.

Phased array antenna and access points are well know in the wireless arts and therefore are not explained here in detail. For the purposes of the present invention it should suffice to say that phased array access points can be provided that, essentially, transmit data along transmission profiles that have many different characteristics but that, generally, will become wider at greater distances from the access point locations (e.g., are generally pie or tier shaped). In addition, directional or phased array access points can also typically be controlled to monitor specific spaces or receive profiles for signals received along trajectories associated therewith.

While it is contemplated that two or more profiles may be employed by a single phased array access point at a time, in most embodiments each access point will only employ a single profile at any given time and the different profiles will be interleaved together in time. For example, in the case of the profiles of FIG. 3, access point 11b may transmit signals along profile 90 first, then transmit along profile 92 and finally transmit along profile 94, thereafter repeating the sequence. The profiles are generally employed in rapid succession such that the location of a WID 30 within facility 10 will change only minimally, if at all during a profile sequence.

A receiving WID 30 has to be able to determine the originating access point and profile corresponding to each received set of signals. Thus, according to one embodiment of the invention, each data packet transmitted from an access point 11 to a WID 30 may indicate both a transmitting access point identifier as well as a profile identifier indicating the profile corresponding to the signal.

In the alternative, in other embodiments, periodic data packets may be dedicated to transmitting profile sequence information related to a set of subsequently transmitted profiles. For instance, where an access point generates ten separate profiles, a first data packet may include a profile sequence indicating the profiles and their sequence corresponding to the next ten packets. Here a WID 30 receives the first packet and is programmed to correlate the profile specifying information therein with the next ten packets when those packets are received. This solution is advantageous where a set communication and data packet protocol already exists and must be employed to communicate. For instance, in the case of the wireless 802.11b protocol, data packet size and structure is set and it may be difficult to provide profile and access point location information within each packet along with other information required by the protocol.

As another alternative, where a profile sequence is repeated (e.g., an access point repeatedly generates the same ten profiles in the same sequence), the sequence may be transmitted once and stored in a WID memory and then a re-sync signal may be periodically transmitted to the WID as part of a conventional data packet which can be used to resynchronize the WID with the profiles being received. Thus, for instance, in the above example, where an access point generates ten separate profiles, after the profile sequence is stored in the WID memory, every tenth data packet may include a re-sync signal indicating the beginning of the profile sequence.

According to yet one other alternative, where all facility access points 11 are controlled by a single controller 38, the controller may periodically transmit profile sequence information related to subsequent profiles to be transmitted for all access points within the facility or within a sub-space within the facility via an access point. Thereafter, when a WID 30 receives a signal from an access point, the WID may be programmed to identify the access point and correlate the signal and point with the expected profile (e.g., the previously received profile from the profile sequence).

When a WID receives data, the WID correlates the received data with a specific access point and a specific transmission profile and stores that data in a WID memory as a learned location specific data set. Once sufficient data has been obtained, a WID processor performs the statistical locating algorithm to estimate WID location which is then used to facilitate whatever location based function the system has been configured to perform.

In addition to increasing the amount of data available for statistical analysis in the manner described above, phased array access points for generating data useful in statistical location estimating algorithms have other advantages. For example, phased array points enable system configurations where access points required to generate the amount of data needed to perform the estimate can be more closely located without causing signal frequency errors. Thus, for instance, where an algorithm requires four different data sets to provide a suitable statistical location estimate, whereas previous configurations would have required four access points with overlapping omni-directional profiles, a configuration according to the present invention may require only two access points, each supporting two separate profiles. In the example, the amount of profile overlap is reduced appreciably and hence frequency errors are also minimized.

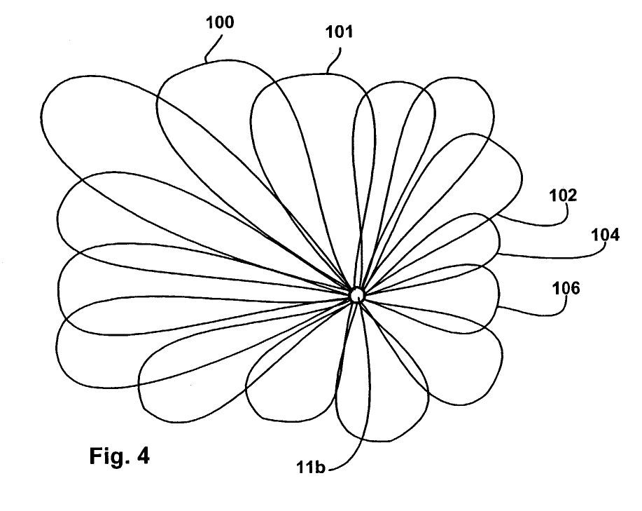

Referring now to FIG. 4, a schematic similar to the schematic illustrated in FIG. 3 is provided that shows the location of a single omni-directional access point 11b and fifteen exemplary transmission/reception profiles 100, 101, 102, 104, 106, etc., that access point 11b may be programmed to employ. As can be seen, while each of the profiles has a similar shape, point 11b may be used to employ many differently trajected profiles having various strengths, angular spans and so on. Such capabilities are advantageous as the area effectively monitored by specific access points can be tailored to be other than circular and generally to accommodate various access point layouts while still minimizing frequency and channel errors.

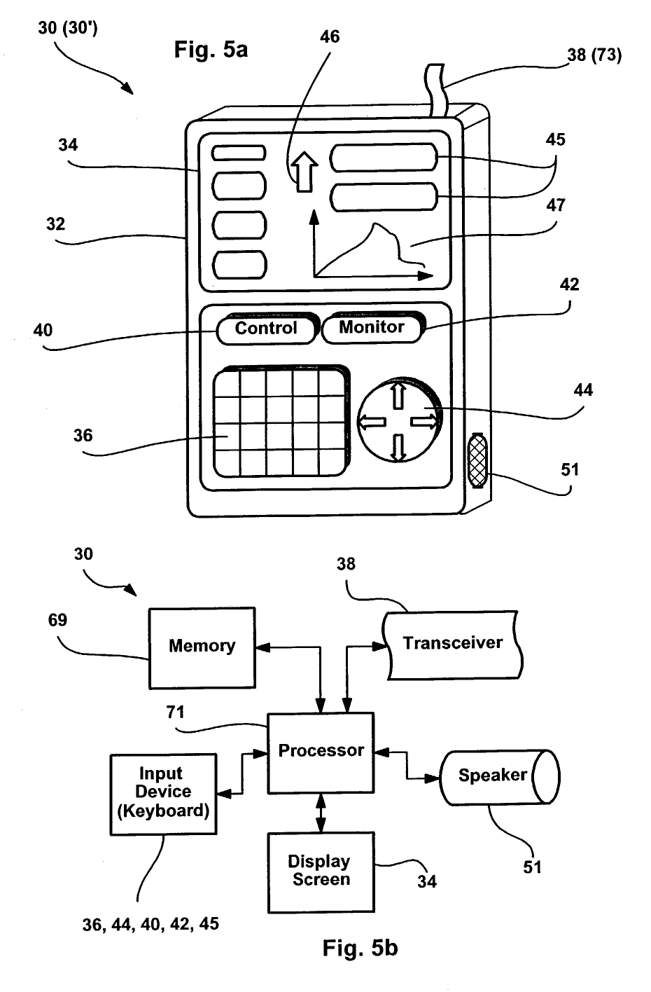

Referring now to FIG. 5a, a perspective view of an exemplary WID 30 is illustrated. Other components of exemplary WID 30 are illustrated in FIG. 5b. Exemplary WID 30 includes, generally, a plurality of components that are mounted within a hardened plastic or metallic housing identified by numeral 32. WID 30 components include a processor 71, an input device (e.g., keyboard 36), a display screen 34, a speaker 51 for audio output, a transceiver 39 and a memory 69. Processor 71 is linked to each of the input device, display screen 34, speaker 51, transceiver 39 and memory 69 for communication therewith. Processor 71 is equipped to run various programs for both displaying information via screen 34 and for receiving control signals and communicating those control signals to access points 11 (see again FIG. 1) via transceiver 39.

The input device may include any of several different types of input components including a typical push-button keyboard 36, separate selection buttons 40 and 42, a rocker-type selection button 44, and/or selectable icons that may be provided via display screen 34 such as, for instance, icons 45. It is contemplated that, in at least one embodiment, a pointing cursor 46 may be movable about screen 34 and placed over one of the selectable icons (e.g., 45) after which a conventional type mouse clicking action may be used to select one of the icons to cause some display or control function to occur. In other embodiments display 34 may comprise a touch screen where icons are selectable via a stylus or the tip of an operators finger.

Display screen 34 may be any type of conventional display screen suitable for a handheld device and, for example, may be equipped to display numeric information, icons, graphs such as graph 47, bar charts, or any other type of monitoring and control information that may be associated with facility machines.

Speaker 51 is a conventional small audio output speaker which may be used for any purpose such as providing an audible indication when a WID 30 is removed from a zone, providing operating characteristics in an audible manner, etc.

Transceiver 39 is mounted proximate the top end of housing 32. In at least some embodiments of the invention transceiver 39 is omni-directional and capable of transmitting electromagnetic signals and also receiving such signals so that information can be provided to controller 38 or received from controller 38 via access points 11.

Memory 69 stores the programs performed by processor 71 and also, in at least some embodiments of the invention, stores a WID identifier (e.g., a WID number, a WID user identification number, etc.). It is contemplated that some WIDs 30 may only be configured to provide access information and, in this case, the programs stored in memory 69 may only be access type programs. Where a WID 30 is equipped with control capabilities, control programs are stored in memory 69.

Referring once again to FIG. 1, hereinafter, according to a first embodiment of the present invention, it will be assumed that each of the access points 11 includes a phased array or directional antenna capable of generating a plurality of different signal profiles like the profiles illustrated in FIG. 4. While each of access points 11 may be capable of generating profiles that are similar to the profiles generated by the other access points 11, it may be that the numbers of profiles generated by each access point 11 and the shapes of the profiles may be appreciably different. For instance, the upper left hand access point 11a in FIG. 1 may generate four different signal profiles while the lower right hand access point 11b in FIG. 1 may generate the fifteen different signal profiles illustrated in FIG. 4. In the alternative, the upper left hand access point 11a in FIG. 1 may generate four profiles that are constrained to the upper left hand one-fourth of facility space 14 while the lower right hand access point 11b in FIG. 1 generates profiles that together essentially cover space 14 where channels permit. In this first embodiment it will also be assumed WID 30 includes an omni-directional transceiver 39 as described above.

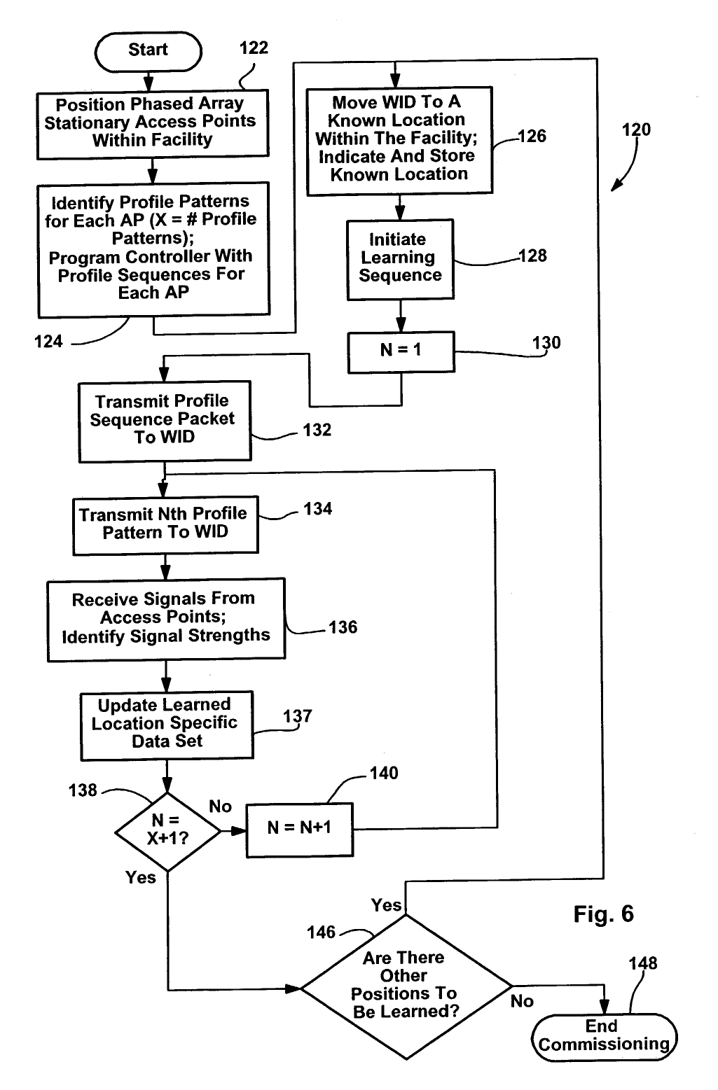

Referring now to FIG. 6, an exemplary method 120 for commissioning a system like the system of FIG. 1 is illustrated. Many of the steps of process 120 are performed for each of the access points 11 illustrated in FIG. 1 and may occur in parallel for each of the access points 11. Nevertheless, in order to simplify explanation of the present invention, process steps in method 120 that are performed for each access point 11 in FIG. 1 will be described in the context of access point 11b.

In FIG. 6, at block 122, phased array access points 11 are positioned within facility 10 at stationary locations. Next, at block 124, a facility employee commissioning the system identifies a plurality of different profile patterns to be employed by each of access points 11. Here, the profile patterns employed by each of the access points 11, as indicated above, may be identical or, in the alternative, may be different, depending upon the physical characteristics of facility 10, the relative locations of the access points, etc. Thus, access point 11a may generate only four profiles during operation whereas access point 11b, as illustrated in FIG. 4, may generate fifteen separate and distinct profiles during operation. After appropriate profiles for each access point have been identified, controller 38 is programmed to cause each of the access points 11 to transmit signals defining the identified profiles and to sequence the profiles according to a profile sequence. In addition, at block 124, a separate value X is set for each one of the access points 11 indicating the number of profile patterns to be generated by the corresponding access point. For instance, consistent with the example above, where access point 11a generates four profiles, value X is set equal to four, while, where access point 11b generates fifteen separate profiles during operation, value X for access point 11b is set to fifteen.

Referring still to FIG. 6 and also to FIG. 1, at block 126a WID user moves a WID 30 to a known location within facility 10 and indicates the known location. Known location may be indicated in any manner including using one of the interface mechanisms on the WID 30 (see again FIG. 5a). WID 30 stores the known location in memory 69.

At block 128, the WID user initiates a learning sequence. To this end, the user may cause a learning sequence initiation signal to be transmitted from the user's WID 30 to controller 38 via access points 11. In some cases the learning sequence may be initiated without transmitting a signal to the controller 38. For example, the access points 11 may be programmed to routinely transmit signals along different profiles that are useable for commissioning and subsequent device location processes. Here, the learning sequence is initiated by simply causing the WID 30 to begin a location learning process.

Each of blocks 130, 132, 134, 136, 138 and 140 represent process steps that are performed for each of access points 11 within facility 10. Steps 130 through 140 will be described in the context of access point 11b to simplify this explanation.

Referring to block 130, after the learning sequence has been initiated, WID processor 71 sets a counter N for access point 11b equal to one. Counter N indicates which profile out of the X profile patterns corresponding to a specific access point is going to be transmitted next by access point 11b.

Referring still to FIG. 6, at block 132, access point 11b transmits a profile sequence packet within space 14. In this regard, referring once again to FIG. 4, access point 11b transmits a profile sequence packet defining each of the fifteen profiles (e.g., 100, 102, 104, 106, etc.) and the order in which those fifteen profiles is to be subsequently transmitted by access point 11b within facility space 14. Here, in one embodiment, controller causes access point 11b to broadcast the profile sequence packet omni-directionally within space 14 to ensure that WID 30 receives the sequence packet. In other embodiments controller 38 may use the separate access point profiles to determine an optimal communication trajectory and then may communicate with the WID 30 along the optimal trajectory.

Next, at block 134, access point 11b begins transmitting the fifteen profile patterns, one profile pattern at a time within space 14. Thus, for instance, access point 11b may begin by transmitting signals defining profile pattern 100 at block 134 and, the next time through block 134, may transmit signals defining another of the fifteen profile patterns of FIG. 4 and so on.

At block 136, WID 30 receives signals from access point 11b and from other access points transmitting signals (again, much of process 120 is performed in parallel for each facility access point), and identifies the strengths of the received signals. At block 137, the signal strengths, access point identifiers and specific profiles are stored along with the known WID location that was provided at block 126 to form a “learned” location specific data set including a separate location specific sub-set for each access point/profile combination. The information stored which specifically identifies the access point and corresponding profile pattern may simply be a profile pattern number where profile patterns are uniquely identified by numbers. In the alternative, the information may include both an access point ID and a profile pattern indicator where similar pattern indicators are used for each of the access points.

Continuing, at block 138, counter N is compared to the profile pattern number X plus one (e.g., X+1). In the present case, where only pattern 100 has been employed, N is equal to one and, therefore is not equal to X+1 (i.e., sixteen in the present example). Thus, control passes from block 138 to block 140 where counter N is incremented by one prior to control passing back up to block 134. Again, at block 134, access point 11b transmits the Nth or, in the present example, the second profile pattern in the profile sequence within space 14. The loop through blocks 134, 136, 137, 138 and 140 continues until counter N is equal to X+1.

Each time through the loop, at block 137 the WID processor 71 updates the learned location specific data set to include additional location specific data sub-sets corresponding to each additional access point/profile combination. Thus, for instance, where a WID 30 is positioned at a facility location where the WID 30 receives signals corresponding to profiles from four separate access points and each point employs four separate profiles, after four passes through the loop for each point, sixteen separate learned location specific data sub-sets will be generated and stored for the specific WID location.

When counter N is equal to X+1 control passes to block 146. At block 146, where no other facility locations are to be learned, control passes to block 148 where the commissioning process is ended. Referring again to block 146 where other facility positions have to be learned and correlated with a location specific data set, control passes back up to block 126 where the WID user moves the WID 30 to another known location within the facility and again identifies the location prior to initiating the learning sequence at block 128. This learning process is repeated for a plurality of locations within facility 10 and correlated locations, access point identifiers, profiles and signal strengths are stored within WID memory 69 for subsequent use.

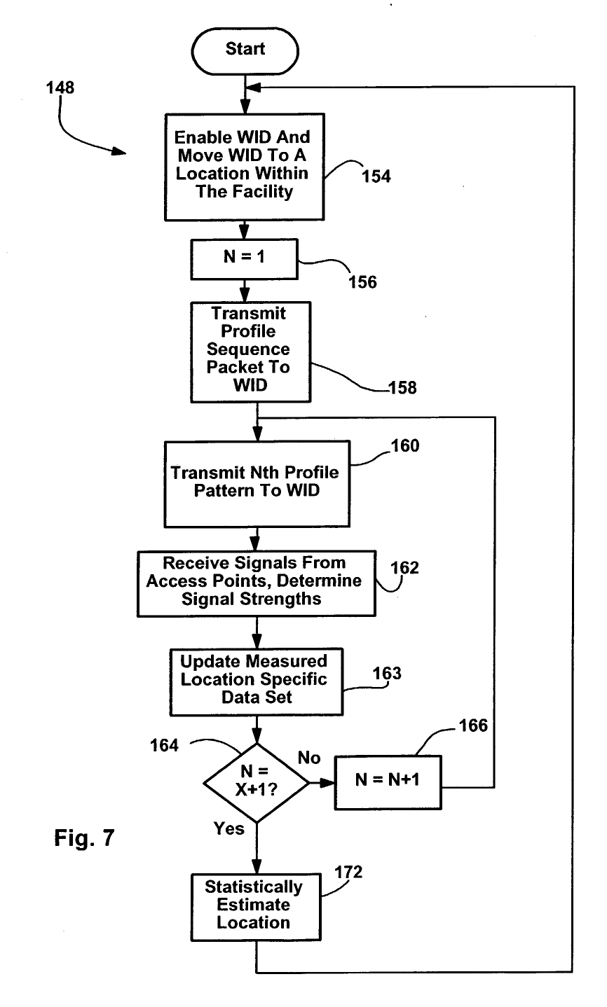

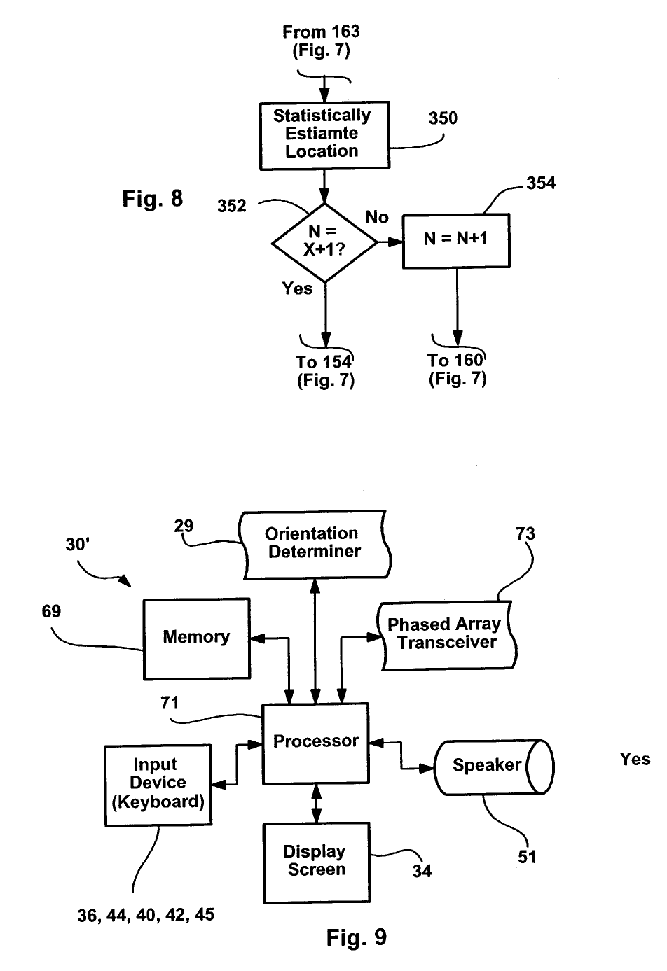

Referring now to FIG. 7, an exemplary method 148 for employing the system described above and the commissioning data (e.g., the learned location specific data sets) stored in memory 69 is illustrated. Without knowing the actual location of a WID 30 within facility 10, at block 154, a WID user moves the WID 30 to a location within facility 10 and enables the WID 30 to communicate with access points 11 and determine WID 30 location.

As above in FIG. 6, the process steps 156, 158, 160, 162, 164, and 166 are generally performed in parallel for each of the access points 11 within facility 10. However, once again, in order to simplify explanation of the present invention, process steps 156 through 166 will only be described in the context of access point 11b unless indicates otherwise.

Continuing in FIG. 7, at block 156, a counter N akin to the counter N described above with respect to FIG. 6 is set equal to one by WID processor 71 for access point 11b. At block 158, access point 11b transmits a profile sequence packet within space 14. Here, the profile sequence packet is identical to the profile sequence packet which was used at block 132 in FIG. 6 during the commissioning procedure and, therefore, in the case of access point 11b, indicates each of the fifteen different profiles illustrated in FIG. 4 and the sequence in which those profiles are to be transmitted within space 14.

In some embodiments access points may transmit the profile sequence packets in response to a signal received from a WID. In this case, as above, controller 38 may be programmed to identify an optimal profile trajectory and transmit the profile sequence packet therealong. In other embodiments where controller 38 has no way of initially knowing optimal communication trajectories, controller 38 may cause access points to transmit omni-directionally.

Continuing, at block 160, the Nth profile pattern corresponding to access point 11b is transmitted to WID 30. At block 162, WID 30 receives the signals from access point 11b, identifies the signal strengths and stores the signal strength values and access point/profile patterns as a measured location specific data set in WID memory 69. At block 164, counter N is compared to value X+1. Where counter N is less than value X+1, control passes to block 166 where counter N is incremented by one before control passes back up to block 160. The loop through blocks 160, 162, 164 and 166 is repeated until all profile patterns in the profile sequence have been transmitted to WID 30. Each time through the loop the measured location specific data set is updated to include additional access point/profile/signal strength data sub-sets. When counter N is equal to value X+1, control passes to block 172 where processor 71 estimates the location of the WID 30 based on a comparison of the measured location specific data set and the learned data sets stored in memory 69. Once WID 30 location is determined a location based function is performed. After block 172 control passes back up to block 154 where the location determining process is repeated. The process of FIG. 148 is performed essentially in real time so that, as a WID 30 is moved within facility 10, WID location is updated seemingly instantaneously.

Referring still to FIG. 7, the location estimation step 172 may take any of several different forms and the invention herein should not be limited to any one form. Generally, where a large number of locations are “learned” during the commissioning process, in at least some embodiments, a straight forward comparison of the measured data set and the learned data sets in memory 69 will yield a close correlation (e.g., essentially a match) and a relatively accurate WID location will be identified. In other cases where fewer locations are learned during commissioning, the measured and learned data will typically not match and some type of interpolation between learned data sets will be required. Here, statistical algorithms like the algorithms in the '813 reference described above will be particularly useful.

Instead of updating location only every time a complete set of new measured data is generated as illustrated in FIG. 7, each new access point/profile/signal strength sub-set may be used to replace an existing corresponding access point/profile/signal strength sub-set thereby generating a sort of “rolling average” measured location determining process. For instance, referring again to FIG. 4, assume profile 100 is the first profile in the sequence used by point 11b, that a complete access point/profile/signal strength sub-set has been generated for point 11b and has been used to estimate WID 30 location. Also assume that, consistent with FIG. 7, the locating process is cyclical and hence continues to be repeated. In this case, the next time through blocks 160, 162 and 163 when N is 1, profile 100 (see FIG. 4) is transmitted and received. The resulting signal strength data is correlated with the access point/profile 100 combination and is then used to replace the existing access point/profile 100/signal strength combination. Thereafter the updated location specific data set is employed immediately to estimate location.

A sub-process for using a rolling updated measured data sub-set that may be used to replace blocks 164, 166 and 172 in FIG. 7 is illustrated in FIG. 8. Referring to FIG. 7, after the measured location specific data set is updated at block 163, control passes to block 350. At block 350a statistical WID location estimation is performed. After location is estimated, control passes to decision block 352 where WID processor 71 determines if value N is equal to X+1. Where value N is less than X+1, control passes to block 354 where value N is incremented by one and control passes back up to block 160 in FIG. 7. At block 352, where value N is equal to X+1, control passes back up to block 154 in FIG. 7.

In a second embodiment of the present invention, it is contemplated that, instead of providing access points with phased array or directional antennas, a phased array or directional antenna or transceiver may be provided on each WID 30 and the access points 11 may be omni-directional. Here, it has been recognized that additional data for performing a statistical analysis of WID location can be generated by, in effect, using a phase array antenna on the WID to generate a plurality of different signal profiles in a time sequenced fashion.

In this embodiment and in other embodiments where WID signals are received by access points and used to determine WID location, the access points are programmed to tag data transmitted to controller 38 to indicate the access point that received the signals (e.g., an access point identifier tag is included with signals strength information and the WID identifier tag).

Referring to FIG. 9, a schematic of components of a second type of WID 30′ including a phased array antenna is provided. The components in FIG. 9 include all of the components identified above with respect to FIG. 5b. However, in FIG. 9, the transceiver of FIG. 5b is replaced by phased array transceiver 73. In addition, an orientation determiner 29 has been added to the WID 30′ of FIG. 9. The orientation determiner 29 is required so that profiles generated by the WID can be oriented in an expected direction. For example, where one profile generated by WID 30′ is expected to be directed along a northward direction, the phased array transceiver 73 must be controlled, despite WID orientation, to generate the profile along a northern trajectory. For instance, referring again to FIG. 5a, where the top end (e.g., the end from which transceiver 73 extends) faces in a northward direction, processor 71 will control the transceiver 73 in one fashion to generate a profile extending along a northern trajectory whereas, if the top end of WID 30′ is facing westward, processor 71 will control transceiver 73 in a second manner to generate a profile extending along a northern trajectory, and so on.

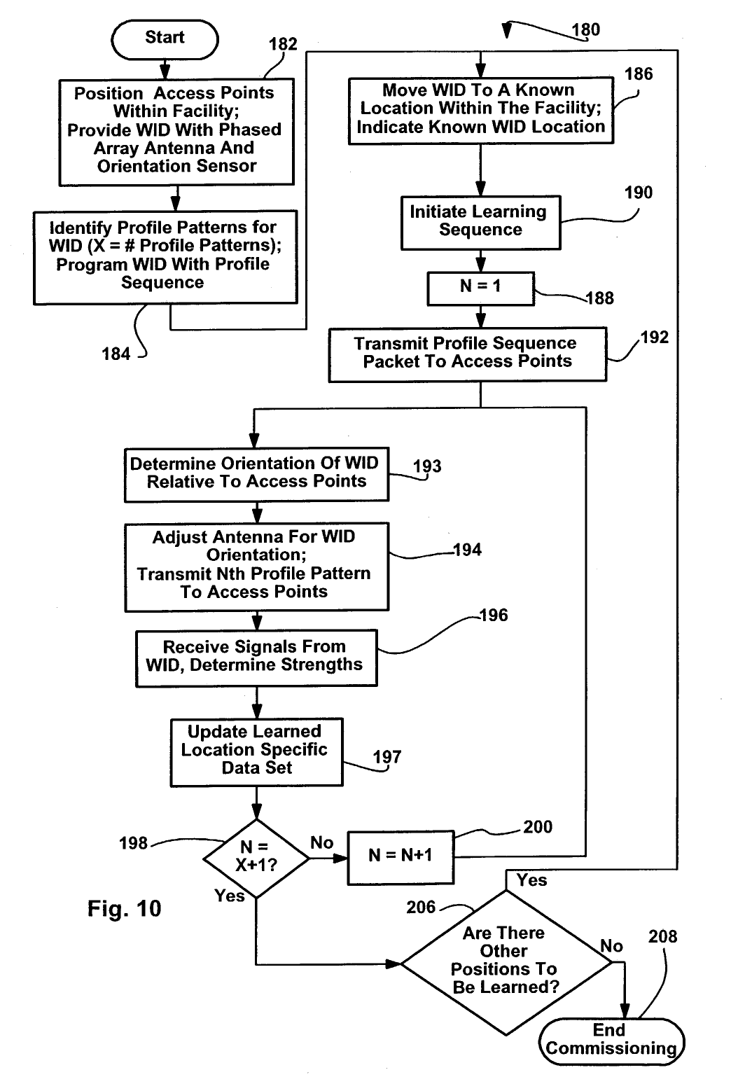

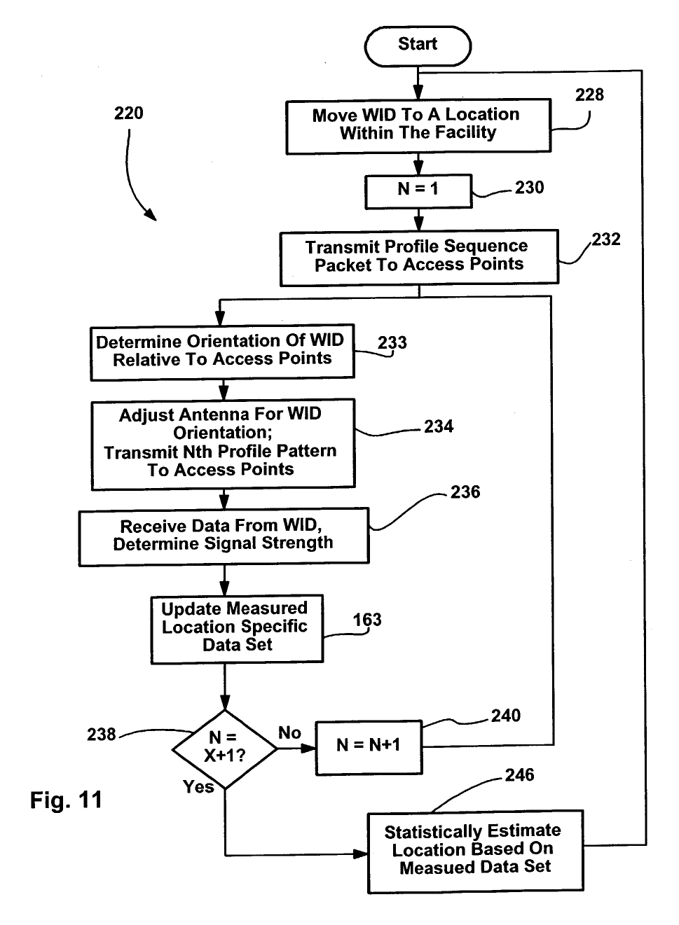

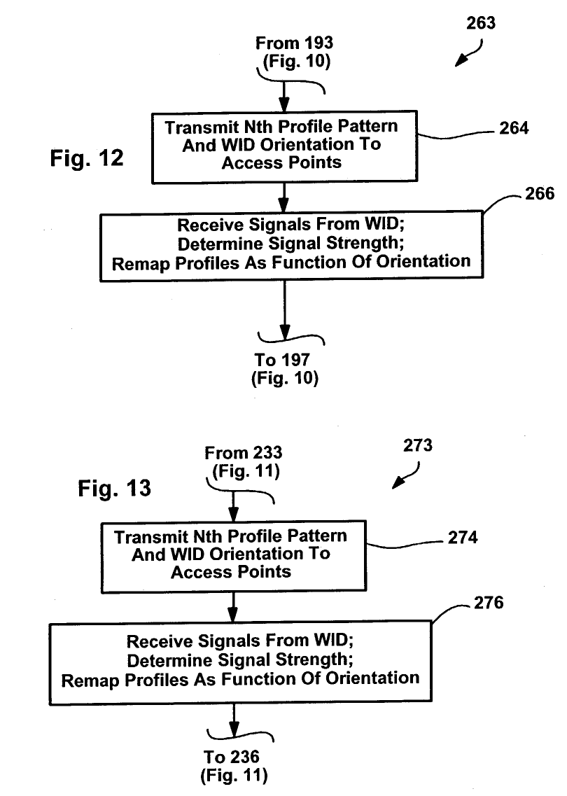

Referring now to FIG. 10, an exemplary inventive process 180 for commissioning a system including a WID 30′ having both an orientation determiner 29 and a phase array transceiver 73 (see again FIG. 9) is illustrated. Referring also to FIG. 1, beginning at block 182, a system designer positions access points 11a, 11b, etc., within facility space 14 wherein each access point is programmed to include access point identifier tags with signal strength data transmitted to controller 38. In addition, at block 182, a WID 30′ having the components described with respect to FIG. 9 is provided.

At block 184, the system designer identifies X profile patterns for WID 30′ and programs WID 30′ to use the profile patterns identified to indicate the profile sequence that will be used by WID 30′ during operation. At block 186, a system user moves the WID 30′ to a known location within the facility and indicates the known location via input to WID 30′. At block 190, the WID user initiates a learning sequence. Here, again, initiation of the learning sequence may take any of several different forms and, may also include transmitting the known WID location to controller 38 via access points 11. In at lease some embodiments, transmission of a learning sequence and initiation signal will be omni-directional from WID 30′ to ensure that the signal is received by at least one access point 11 linked to controller 38.

Next, at block 188, a counter value N akin to the counter value N described above with respect to FIGS. 6 and 7 is set equal to 1. At block 192, the WID 30′ transmits the profile sequence packet that was defined at block 184 to the access points 11.

At block 193, orientation determiner 29 (see again FIG. 9) determines the orientation of WID 30′ relative to the access points. At block 194, WID processor 71 adjusts the phased array transceiver or antenna to compensate for WID orientation and causes phased array transceiver 73 to transmit the Nth profile pattern to the access points 11.

Continuing, at block 196, the access points 11 receive signals from WID 30′, determine the strengths of those signals and provide data packets to controller 38 including a WID identifier, the Nth profile pattern, the access point identifier and the corresponding signal strength. At block 197, controller 38 updates a learned location specific dataset stored in database 40. After block 197, control passes to block 198 where WID processor 71 compares counter value N to the value X+1. Where value N is less than value X+1, control passes to block 200 where counter value N is incremented by 1 prior to control passing back up to block 193. The process including blocks 193, 194, 196, 197, 198 and 200 continues until, at block 198, value N is equal to value X+1.

When the condition at block 198 is reached, control passes from block 198 to block 206. At block 206, if there are no other positions to be learned during the commissioning process, control passes to block 208 and the commissioning process is completed. However, at block 206, where additional positions must be learned to complete the commissioning process, control passes back up to block 186 where the WID user moves the WID to yet another known location within the facility 10 and the process is repeated.

Referring now to FIG. 11, a process 220 for use with a WID including an orientation determiner 29 and a phased array receiver 73 as illustrated in FIG. 9 and for use with omni-directional access points to determine WID location after a commissioning process has been completed is illustrated. Beginning at block 228, a WID user moves a WID 30′ into a location within facility 10. Once the WID 30′ has been enabled to transmit signals to access points 11 control passes from block 228 to block 230 where a counter value N is set equal to 1. Next, at block 232, the WID 30′ transmits a profile sequence packet indicating the sequence of profiles corresponding to subsequent data transmissions to the access points 11. At block 233, orientation determiner 29 (see again FIG. 9) determines the orientation of WID 30′ relative to the access points. At block 234, WID processor 71 adjusts the phased array antenna or transceiver 73 of WID 30′ to compensate for the instantaneous WID orientation. In addition, at block 234, processor 71 transmits the Nth profile pattern to access points 11 via transceiver 73.

At block 236, the access points 11 receive data from the WID 30′ and determine the signal strength. At block 237, controller 38 updates the measured location specific dataset by storing a WID identifier/profile/signal strength/access point combination corresponding to the most recently received WID signals. At block 238, WID processor 71 compares counter value N to value X+1. Once again, where counter value N is less than value X+1, control passes to block 240 where counter value N is incremented by 1 prior to control passing back to block 233. The loop including blocks 233, 234, 236, 237, 238 and 240 is repeated until counter value N equals X+1. When the condition at block 238 is achieved, control passes from block 238 to block 246 where controller 38 performs a statistical estimation of WID location based on the measured data set as described above.

In some embodiments, instead of adjusting the phased array antenna on a WID to compensate for orientation of the WID, a system controller 38 may adjust for WID orientation after signals are received from a WID. To this end, a sub-process 263 that may be substituted for blocks 194 and 196 in FIG. 10 to provide yet another commissioning procedure is illustrated in FIG. 12. Referring also to FIG. 10, after the orientation determiner 29 on the WID 30′ has determined the orientation of the WID relative to the access points, control passes to block 264 in FIG. 12 where processor 71 transmits the Nth profile pattern and WID orientation information via transceiver 73 to the access points 11. Next, at block 266, controller 38 uses the received signals, including the WID orientation signal, to remap the received signals to required profiles as a function of WID orientation. After block 266 control passes back to block 197 in FIG. 10 and the process 180 of FIG. 10 is continued.

FIG. 13 illustrates a sub-process 273 that may be substitutes for blocks 234, 236 in FIG. 12 to provide a modified process wherein controller 38 compensates for WID 30′ orientation. To this end, referring also to FIG. 12, after block 233, control passes to block 274 in FIG. 13 where WID 30′ transmits the Nth profile pattern and WID orientation information to access points 11. At block 276, controller 38 uses the received signals including the profile pattern and the WID orientation to remap the signals to required profiles as a function of WID orientation. In addition, at block 276, controller 38 and access points 11 cooperate to determine the strength of the received signal. After block 276 control again passes to block 237 in FIG. 12 where process 220 is continued as described above.

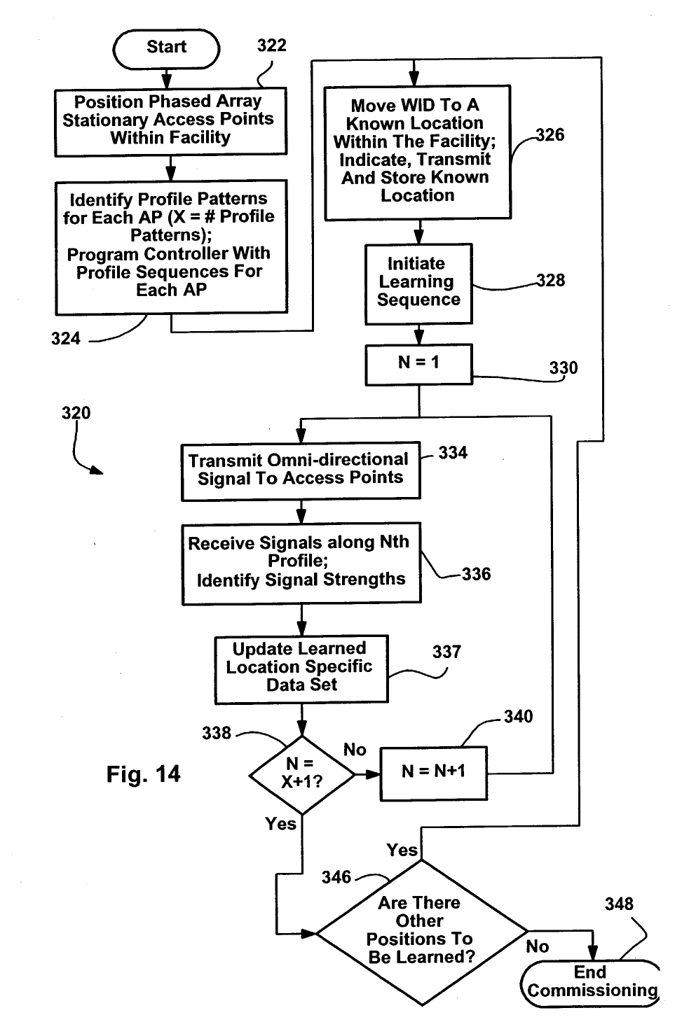

According to yet one more embodiment of the invention, instead of taking advantage of the additional data that may be generated by transmitting signals along different profiles, it has been recognized that additional data may also be generated by monitoring different profiles for omni-directionally transmitted signals. To this end, referring to FIG. 14, an exemplary method or process 320 for using phased array access points to receive signals from a WID and generate additional data for performing a statistical location analysis is illustrated. In FIG. 14, beginning at block 322, a system designer positions phased array stationary access points within a facility. At block 324, the designer identifies X profile patterns for each access point 11 in the facility and programs controller 38 with the profile sequences for each access point. Here, the profile patterns correspond to access point receiving profiles as opposed to transmitting profiles as described above.

At block 326, a WID user moves a WID 30 to a known location within the facility and uses one of the WID input components to indicate the known location after which the WID processor 71 transmits the known location to the controller 38 via access points 11 and controller 38 stores the known location in database 40 (see again FIG. 1). Continuing, at block 328, the WID user initiates a learning sequence after which, at block 330, controller 38 sets a counter N equal to 1 for each separate access point.

At block 338, the WID 30 transmits omni-directional signals to the access points 11. At block 336, the signals are received by the access points along their respective Nth profiles and the access points identify signal strengths. At block 337, controller 38 updates learned location specific data sets stored in database 40 with the data received and generated at block 336. At block 338 counter N is compared to the value X+1. Again, where the condition at block 338 is not satisfied control passes to block 340 where counter N is incremented by 1 prior to control passing back up to block 334. After the condition at block 338 has been met, control passes to block 346. At block 346, where other positions are to be learned, control again passes back up to block 326. Where all of the positions to be learned during the commissioning procedure have been learned, control passes from block 346 to block 348.

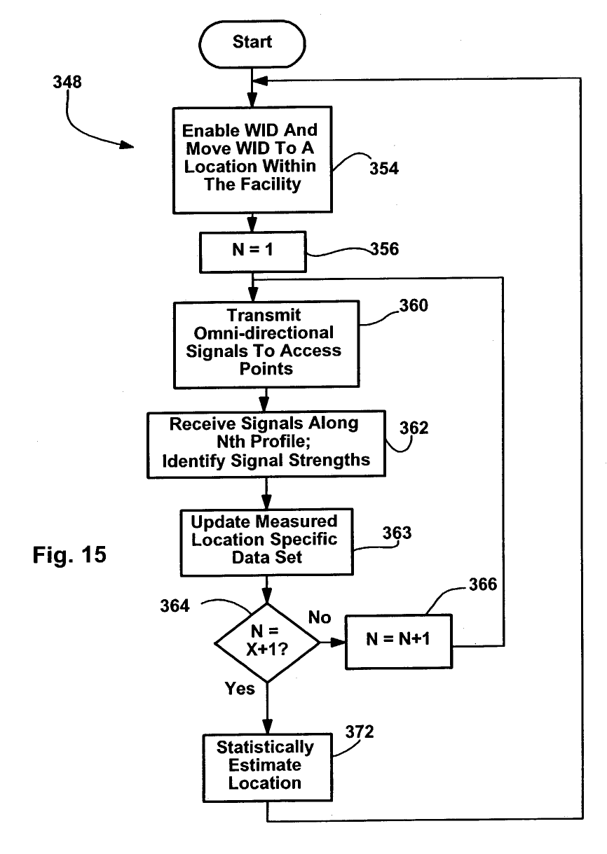

A location determining method 348 to be used after a commissioning procedure like the procedure of FIG. 14 has been completed is illustrated in FIG. 15. Beginning at block 354, an enabled WID is moved into a location within a facility. At block 356 controller 38 sets a separate counter N for each access point to 1.

At block 360, the WID 30 transmits omni-directional signals to access points 11. At block 362, the access points receive signals along their respective Nth profiles. In addition, at block 362, each access point identifies the strength of the received signal along the point's Nth profile. At block 363, the measured location specific data sets stored in database 40 are updated by controller 38. At block 364, counter value N is compared the value X+1. Where the condition of block 364 is not met, control passes to block 366 where counter value N is incremented by 1 prior to control passing to block 354. Where the condition of block 364 is met, control passes to block 372 where controller 38 performs a statistical analysis on the stored measured location specific data set to identify WID location.

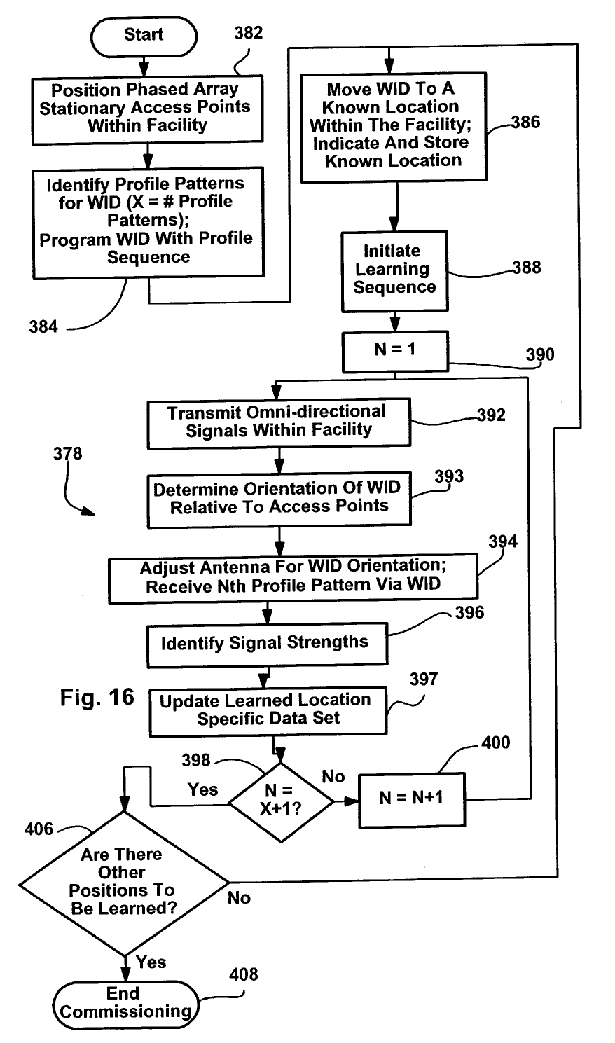

In yet one other embodiment of the invention, the WIDs may be programmed to receive omni-directionally transmitted signals from the access points along specific profiles to generate data for performing statistical analysis. To this end, one method for commissioning a WID processor 71 to perform such a process is illustrated in FIG. 16. At block 382, phased array stationary access points are positioned within a facility. At block 384, a system designer identifies X profile patterns for a WID 30′. In addition, at block 384, the designer programs the WID 30′ with the profile sequence.

At block 386a WID user moves a WID 30′ to a known location within the facility and uses one of the input components of the WID 30′ to indicate the known location which is stored within the WID memory 69. At block 388 the WID user initiates a learning sequence and at block 390 the WID processor 71 sets a counter N to 1.

Continuing, at block 392, the access points are controlled by controller 38 to transmit omni-directional signals within the facility. At block 393, the orientation determiner on the WID determines the orientation of the WID 30′ relative to the access points. At block 394, the WID processor 71 adjusts the phase array antenna of the WID to receive signals along the Nth profile pattern via the WID and signals are then received. At block 396, the WID processor 71 identifies the signal strengths of the received signals and at block 397 the WID processor 71 updates the learned location specific data set in memory 69. At block 398 counter value N is compared to the value X+1. Where the condition of block 398 is not met, control passes to block 400 where counter value N is incremented to 1 prior to control passing back up to block 392. Where the condition of block 398 is met, control passes to block 406 where the WID user indicates whether or not other positions are to be learned via one of the input components of the WID 30′. Where additional positions are to be learned, control passes back up to block 386 and the process repeated. Where additional positions are not to be learned, control passes to block 408 and the commissioning procedure is completed.

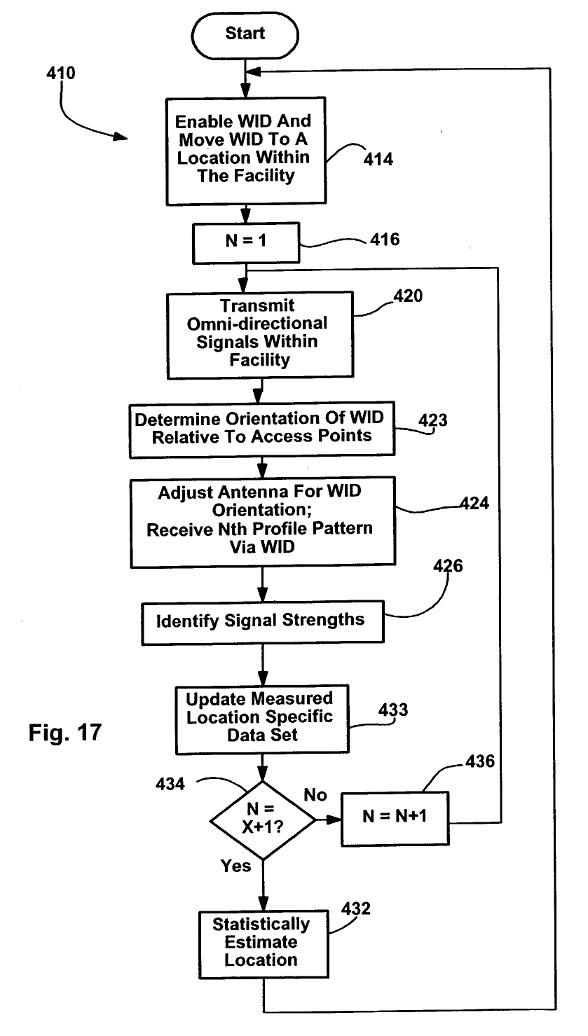

A location determining method 410 to be used after a commissioning procedure like the procedure described above with respect to FIG. 16 is illustrated in FIG. 17. At block 414, an enabled WID is moved to within a location in the facility. At block 416, a WID counter N set equal to 1. At block 420, the access points 11 transmit omni-directional signals within the facility.

Continuing, at block 423, the WID orientation determiner determines the orientation of the WID relative to the access points 11. At block 424, the WID processor 71 adjusts the WID antenna for WID orientation and receives the signals within the Nth profile pattern. At block 426, the WID processor 71 determines the signals strengths and at block 433, the processor 71 updates the measured location specific data set within memory 69. At block 434, counter value N is compared to X+1. Where the condition of block 434 is not met, control passes to block 436 where counter value N is incremented by 1 prior to control passing back up to block 420. Where the condition of block 434 is met, control passes to block 432 where a statistical estimation of WID 30′ location is performed prior to control passing back up to block 414.

While the invention as described above is one wherein either access points or a WID transmitter includes a phased array antenna, the present invention also contemplates systems wherein each of the WID transceiver and the access points or perhaps a sub-set of the access points include phased array capabilities. In addition, the invention also contemplates systems wherein some access points may be omni-directional while other access points have phased array capabilities. In addition, it should be appreciated that, while the invention as described above in the context of a hand-held type wireless information device, the invention is also applicable to other types of wireless information devices such as, for instance, devices that may be attached to portable machinery, a maintenance employee's shop cart, manufacturing supplies and so on.

From the foregoing, it will be observed that numerous modifications and variations can be effected without departing from the true spirit and scope of the novel concept of the present invention. It will be appreciated that the present disclosure is intended as an exemplification of the invention, and is not intended to limit the invention to the specific embodiment illustrated. For instance, where phased array access points transmit signals along different profiles to a WID, the WID may receive the signals, determine signal strengths, correlate the signal strengths with associated profiles and access points and transmit the associated information to controller 38 via one or more access points. Thereafter, controller 38 may perform a statistical analysis of WID location based on similarly generated commissioning data to determine WID location.

As another example, a commissioning procedure may require more than one learned location data set for each known location assumed during the commissioning process. For instance, a WID user may be required to position the WID in several different orientations at a known location and generate separate learned data sets for each of the orientations, thereafter associating each of the data sets with the specific location for subsequent use. Moreover, where the phased array antenna is located on a WID and the WID includes an orientation determiner, WID may correlate orientation with location, profile, etc., for subsequent use. Thereafter, during a WID locating process, a processor performing the process would take orientation into consideration when comparing a measured data set to learned data sets (e.g., each measured data set would include WID or antenna orientation as well as other correlated information (e.g., profile, transmitter, strength, etc.)).

To apprise the public of the scope of this invention, the following claims are made:

What is claimed is:

1. A method for determining the location of an item within a facility wherein the facility includes at least one stationary point, and the item and the stationary point are each facility objects, the method comprising the steps of:
(a) providing a receiver on a first of the objects;
(b) providing a transmitter on a second of the objects, wherein at least one of the receiver and the transmitter includes a phased array antenna;
(c) where the receiver includes the antenna, causing the antenna to receive signals within at least first and second different profiles and causing the transmitter to transmit signals to the receiver;
(d) where the transmitter includes the antenna, causing the antenna to transmit signals having at least first and second different profiles and causing the receiver to receive at least a sub-set of the transmitted signals; and
(e) using the received signals to determine the location of the item.

2. The method of claim 1 wherein the step of providing a receiver includes providing the receiver on the item.

3. The method of claim 2 wherein the step of providing a transmitter includes providing a transmitter having a phased array antenna and wherein the step of causing the transmitter to transmit includes causing the transmitter to transmit signals having at least first and second different profiles.

4. The method of claim 3 wherein the step of causing the transmitter to transmit includes causing the transmitter to transmit signals having first and second profiles that overlap at least in part.

5. The method of claim 3 wherein the step of causing the transmitter to transmit includes causing the transmitter to transmit signals having a plurality of different profiles.

6. The method of claim 3 wherein the step of causing the transmitter to transmit includes the step of causing the transmitter to transmit signals according to a profile sequence, the sequence specifying an order in which the profiles are to be transmitted.

7. The method of claim 6 further including the steps of transmitting profile sequence information from the transmitter to the receiver indicating the profile sequence and using the profile sequence information in addition to the received data to determine the location of the item.

8. The method of claim 7 wherein the step of transmitting includes transmitting data and profile sequence information in discrete data packets.

9. The method of claim 8 wherein the step of transmitting profile sequence information includes transmitting a profile indicator as part of each data packet that specifies the profile along which the data packet is transmitted.

10. The method of claim 8 wherein the step of transmitting profile sequence information includes transmitting a profile packet periodically indicating the profiles corresponding to a sub-set of other data packets.

11. The method of claim 10 wherein the step of transmitting a profile packet includes transmitting a packet indicating the profiles of data packets to be transmitted subsequent thereto and between the profile packet and the next to be transmitted profile packet.

12. The method of claim 1 wherein the step of using the signals includes performing a statistical analysis on the received signals to determine the location of the item.

13. The method of claim 6 further including, prior to step (e), performing a commissioning procedure including receiving a known location identifier, transmitting commissioning profiles within the facility, identifying the transmitter/profile combination for each received signal, identifying the strength of each received signal, correlating the transmitter/profile/signal strength combinations with the known location identifier to generate a learned location specific data set for the known location and storing the learned data set in a database.

14. The method of claim 13 wherein the step of using the received signals includes identifying the transmitter/profile combination for each received signal, identifying the strength of each received signal, correlating the transmitter/profile/signal strength combinations to generate a measured location specific data set for the known location and comparing the measured data set to the learned data sets.

15. The method of claim 14 wherein the step of comparing further includes identifying the learned data set that most closely matches the measured data set and using the location specified by the most closely matching learned data set to estimate item location.

16. The method of claim 14 wherein the step of comparing further includes identifying the learned data sets that most closely match the measured data set and combining the at least a sub-set of the data in the most closely matching learned data sets to estimate item location.

17. The method of claim 16 wherein the step of combining at least a sub-set includes combining the locations associated with the most closely matching learned data sets.

18. The method of claim 17 wherein the step of combining the locations includes interpolating between the locations associated with the most closely matching learned data sets.

19. The method of claim 13 wherein the commissioning profiles are identical to the profiles used in step (d).

20. The method of claim 13 wherein the commissioning profile sequence includes a sequence that is substantially similar to the profile sequence subsequently used in step (d).

21. The method of claim 2 wherein the step of providing a receiver includes providing a receiver having a phased array antenna and wherein the step of causing the receiver to receive includes causing the receiver to receive signals along at least first and second different profiles.

22. The method of claim 1 wherein the step of providing a receiver includes providing the receiver on the stationary object.

23. The method of claim 22 wherein the step of providing a transmitter includes providing a transmitter having a phased array antenna and wherein the step of causing the transmitter to transmit includes causing the transmitter to transmit signals having at least first and second different profiles.

24. The method of claim 23 further including the steps of providing an orientation determiner on the item that identifies the orientation of the item when a signal is transmitted and using the determined orientation to modify the signal strengths prior to association with the profiles.

25. The method of claim 23 further including the step of providing an orientation determiner on the item that identifies the orientation of the item prior to transmitting a signal and using the determined orientation to modify the trajectories of the profiles subsequently transmitted.

26. The method of claim 22 wherein the step of providing a receiver includes providing a receiver having a phased array antenna and wherein the step of causing the receiver to receive includes causing the receiver to receive signals within at least first and second different profiles.

27. The method of claim 3 wherein there are several stationary points within the facility and wherein the step of providing a transmitter includes providing a separate transmitter at each of the stationary points.

28. The method of claim 27 wherein each of the transmitters includes a phased array antenna and each antenna transmits along at least first and second different profiles.

29. The method of claim 1 further including, prior to step (e), performing a commissioning procedure including receiving a known location identifier, transmitting commissioning profiles within the facility, identifying the transmitter/profile combination for each received signal, identifying the strength of each received signal, correlating the transmitter/profile/signal strength combinations with the known location identifier to generate a learned location specific data set for the known location and storing the learned data set in a database.

30. The method of claim 29 wherein the step of performing a commissioning procedure includes repeating the commissioning procedure at least first and second times at the known location with the item in at least first and second different orientations at the known location.

31. The method of claim 30 wherein the phased array antenna is on the item and wherein the method further includes the steps of determining the orientation of the item when signals are received and correlating the orientation with the transmitter/profile/signal strength combination to generate the learned position data set prior to storage.

32. The method of claim 31 further including the step of, prior to step (e) and after the commissioning procedure, determining the orientation of the item when signals are transmitted along specific profiles and wherein the step of using the signals includes correlating the transmitter/profile/signal strength/orientation combinations to generate a measured location specific data set for the known location and comparing the measured data set to the learned data sets.

33. The method of claim 32 wherein the step of comparing further includes identifying the learned data set that most closely matches the measured data set and using the learned data set that most closely matches the measured data set to estimate item location.

34. A method for determining the location of an item within a facility wherein the facility includes at least one stationary point, the method comprising the steps of:
(a) providing a receiver on the item;
(b) providing a transmitter including a phased array antenna at the stationary point;
(c) causing the antenna to transmit signals within the facility having at least first and second different profiles;
(d) receiving at least a sub-set of the transmitted signals via the receiver; and
(e) performing a statistical analysis on the received signals to determine the location of the item.

35. The method of claim 34 wherein the step of causing the transmitter to transmit includes the step of causing the transmitter to transmit signals according to a profile sequence specifying an order in which the profiles are to be transmitted.

36. The method of claim 35 further including the steps of transmitting profile sequence information to the receiver indicating the profile sequence and using the profile sequence information in addition to the received data to determine the location of the item.

37. The method of claim 34 further including, prior to step (e), performing a commissioning procedure including receiving a known location identifier, transmitting commissioning profiles within the facility, identifying the transmitter/profile combination for each received signal, identifying the strength of each received signal, correlating the transmitter/profile/signal strength combinations with the known location identifier to generate a learned location data set for the known location and storing the learned data set in a database.

38. The method of claim 37 wherein the step of using the received signals includes identifying the transmitter/profile combination for each received signal, identifying the strength of each received signal, correlating the transmitter/profile/signal strength combinations to generate a measured location specific data set for the known location and comparing the measured data set to the learned data sets.

39. The method of claim 38 wherein the step of comparing further includes identifying the learned data sets that most closely match the measured data set and combining the at least a sub-set of the data in the most closely matching learned data sets to estimate item location.

40. The method of claim 39 wherein the step of combining at least a sub-set includes combining the locations associated with the most closely matching learned data sets.

41. A method for determining location within an area wherein the area includes at least one stationary point, the method comprising the steps of:
(a) transmitting signals from the stationary point along at least first and second different profiles within the area;
(b) receiving at least a subset of the transmitted signals at a location within the area;
(c) determining the signal strengths of the received signals;
(d) correlating the signal strengths with the profiles; and
(e) performing a statistical analysis on at least first and second of the correlated profile/signal strength combinations to determine location within the area.

42. The method of claim 41 further including the step of providing a receiver on an item wherein the step of receiving includes receiving at least a sub-set of the transmitted signals via the receiver and wherein the method is for determining the location of the item within the area.

43. The method of claim 41 wherein the step of providing a transmitter includes providing a plurality of stationary transmitters, each transmitter having a phased array antenna, the step of causing the transmitters to transmit including causing each of the transmitters to transmit along at least first and second different profiles.

44. The method of claim 43 wherein the step of receiving includes receiving at least a sub-set of the signals transmitted by each of the transmitter and the step of correlating includes correlating transmitter/profile/signal strength data to generate the measured location data set.

45. A method for determining location within an area, the method comprising the steps of:
performing a commissioning procedure including the steps of:
(a) transmitting signals from a first location within the area along at least first and second different profiles within the area;
(b) receiving at least a subset of the transmitted signals at a second location within the area, at least one of the first and second locations being a known location;
(c) determining the signal strengths of the received signals;
(d) correlating the signal strengths with the profiles and the known location to generate a learned location data set;
(e) storing the learned data set for sub-sequent use; and
(f) repeating steps (a) through (e) for a plurality of locations within the area.

46. The method of claim 45 wherein the step of transmitting signals from a first location includes transmitting signals from a stationary first location.

47. The method of claim 45 further including the steps of, after the commissioning procedure has been completed:
(g) transmitting signals from the first location within the area along the at least first and second different profiles within the area;
(h) receiving at least a subset of the transmitted signals at a location within the area;
(i) determining the signal strengths of the received signals;
(j) correlating the signal strengths with the profiles to generate a measured location data set; and
(k) comparing the measured data set to the learned data sets to determine location within the area.

48. The method of claim 47 wherein the step of comparing further includes identifying the learned data set that most closely matches the measured data set and using at least a subset of the learned data set that most closely matches the measured data set to determine location.

49. The method of claim 45 further including the step of providing a receiver on an item and wherein steps (a) through (e) are repeated for each area location with the receiver in different orientations.

50. A method for determining location within an area, the method comprising the steps of:
(a) transmitting signals from a first location within the area along at least first and second different profiles within the area;
(b) receiving at least a subset of the transmitted signals at a second location within the area;
(c) determining the signal strengths of the received signals;
(d) correlating the signal strengths with the profiles to generate a measured location data set; and
(e) using the measured data set to determine the second location.

51. A method for determining location within an area, the method comprising the steps of:
(a) transmitting profile sequence information within the area, the sequence information indicating the sequence of X profiles to be transmitted subsequently within the area;
(b) receiving and storing the profile sequence information;
(c) transmitting signals along the X profiles within the area;
(d) receiving at least a sub-set of the transmitted signals at a location within the area;
(e) determining the signal strengths of at least a subset of the received signals;
(f) correlating the signal strengths and the profiles specified by the profile sequence to generate a measured location data set; and
(g) using the measured data set to determine the receiving location within the area.

52. A system for determining the location of an item within a facility wherein the facility includes at least one stationary point, and the item and the stationary point are each facility objects, the system comprising:
(a) a receiver on a first of the objects;
(b) a transmitter on a second of the objects, wherein at least one of the receiver and the transmitter includes a phased array antenna;
(c) where the receiver includes the antenna, a receiver processor causing the antenna to receive signals within at least first and second different profiles and causing the transmitter to transmit signals to the receiver;
(d) where the transmitter includes the antenna, a transmitter processor causing the antenna to transmit signals having at least first and second different profiles and causing the receiver to receive at least a sub-set of the transmitted signals; and
(e) a processor using the received signals to determine the location of the item.

53. The system of claim 52 wherein the receiver is included on the item.

54. The system of claim 53 wherein the transmitter includes the phased array antenna.

55. The system of claim 54 wherein the transmitter is controlled to transmit signals according to a profile sequence, the sequence specifying an order in which the profiles are to be transmitted.

56. The system of claim 55 wherein the transmitter is further controlled to transmit profile sequence information from to the receiver indicating the profile sequence and the receiver is programmed to use the profile sequence information in addition to the received data to determine the location of the item.

57. The system of claim 56 wherein the transmitter transmits profile sequence information by transmitting a profile packet periodically indicating the profiles corresponding to a sub-set of other data packets.

58. The system of claim 52 wherein the processor performs a statistical analysis on the received signals to determine the location of the item.

59. The system of claim 53 wherein the receiver includes the phased array antenna and wherein the receiver receives signals along at least first and second different profiles.

60. The system of claim 52 wherein the receiver is on the stationary object.

61. The system of claim 60 wherein the transmitter includes the phased array antenna and wherein the transmitter transmits signals along at least first and second different profiles.

62. The system of claim 61 further including an orientation determiner that identifies the orientation of the item when a signal is transmitted and wherein the processor uses the determined orientation to modify the signal strengths prior to association with the profiles.

63. The system of claim 61 further including an orientation determiner that identifies the orientation of the item prior to transmitting a signal and wherein the transmitter processor uses the determined orientation to modify the trajectories of the profiles subsequently transmitted.

64. The system of claim 60 wherein the receiver includes a phased array antenna and wherein the receiver receives signals within at least first and second different profiles.

65. The system of claim 54 including several stationary points within the facility and wherein a separate transmitter is located at each of the stationary points.

66. The system of claim 65 wherein each of the transmitters includes a phased array antenna and each antenna transmits along at least first and second different profiles.

67. A system for determining the location of an item within a facility wherein the facility includes at least one stationary point, the system comprising:
(a) a receiver on the item;
(b) a transmitter including a phased array antenna at the stationary point;
(c) a transmitter processor causing the antenna to transmit signals within the facility having at least first and second different profiles; and
(d) a processor programmed to perform a statistical analysis of the received signals to determine the location of the item.

68. The system of claim 67 wherein the transmitter processor causes the transmitter to transmit signals according to a profile sequence specifying an order in which the profiles are to be transmitted.

69. The system of claim 68 wherein the transmitter processor causes the transmitter to transmit the profile sequence information to the receiver indicating the profile sequence and wherein the processor uses the profile sequence information in addition to the received data to determine the location of the item.

70. A system for determining location within an area, the system comprising:
(a) a transmitter transmitting signals from a first location within the area along at least first and second different profiles within the area;
(b) a receiver receiving at least a subset of the transmitted signals at a second location within the area, at least one of the first and second locations being a known location;
(c) a processor determining the signal strengths of the received signals, correlating the signal strengths with the profiles and the known location to generate a learned location data set; and
(d) a memory linked to the processor for storing the learned data set for sub-sequent use.

71. The system of claim 70 wherein the transmitter is at a stationary first location.

72. The system of claim 70 wherein, after a plurality of learned data sets have been stored, the transmitter further transmits signals from the first location within the area along the at least first and second different profiles within the area, the receiver receives at least a subset of the transmitted signals at a location within the area, the processor determines the signal strengths of the received signals, correlates the signal strengths with the profiles to generate a measured location data set and compares the measured data set to the learned data sets to determine location within the area.

73. The system of claim 72 wherein the processor compares by identifying the learned data set that most closely matches the measured data set and using at least a subset of the learned data set that most closely matches the measured data set to determine location.

74. A system for determining location within an area, the system comprising:
(a) a transmitter transmitting signals from a first location within the area along at least first and second different profiles within the area;
(b) a receiver receiving at least a subset of the transmitted signals at a second location within the area; and
(c) a processor that determines the signal strengths of the received signals, correlates the signal strengths with the profiles to generate a measured location data set and uses the measured data set to determine the second location.

75. An apparatus for determining the location of an item within a facility, the apparatus for use with at least one phased array transmitter that transmits signals along at least first and second different profiles within the facility, the apparatus comprising:
a receiver mounted to the item, the receiver for receiving at least a sub-set of the signals transmitted along the different profiles; and
a processor that determines the strengths of the received signals, correlates the received signal strengths with associated profiles and uses the correlated signal strength/profile combinations to determine item location within the facility.

76. The apparatus of claim 75 for use with a plurality of phased array transmitters located within the facility wherein the receiver receives at least a sub-set of the signals transmitted from each of at least two of the transmitters and the processor correlates the received signal strengths with associated transmitter/profile combinations and uses the correlated signal strength/transmitter/profile combinations to determine item location within the facility.

77. The apparatus of claim 75 further including a memory linked to the processor and storing learned location data sets, each learned data set correlating a known facility location with a signal strength/profile combination, the correlated combination identified by the processor being a measured data set and, wherein, the processor uses the measured data set by comparing the measured data set to the learned data sets and using learned data sets that are similar to the measured data sets to determine location of the item.
